(19) United States
(12) Patent Application Publication
(10) Pub. No.: US 2015/0005180 A9
(43) Pub. Date: Jan. 1, 2015

(54) Biochip

(71) Applicants: Kazuhiko Ishihara, Tokyo (JP); Sohei Funaoka, Tokyo (JP); Kanehisa Yokoyama, Tokyo (JP)

(72) Inventors: Kazuhiko Ishihara, Tokyo (JP); Sohei Funaoka, Tokyo (JP); Kanehisa Yokoyama, Tokyo (JP)

(21) Appl. No.: 10/572,332

(22) PCT Filed: Sep. 17, 2004
(86) PCT No.: PCT/JP2004/013656

§ 371 Date: Jul. 11, 2011

(30) Foreign Application Priority Data
Sep. 19, 2003 (JP) 2003-328791
Oct. 7, 2003 (JP) 2003-347712
Oct. 7, 2003 (JP) 2003-347713
Oct. 7, 2003 (JP) 2003-347714
Oct. 7, 2003 (JP) 2003-347715
Dec. 15, 2003 (JP) 2003-417350
Dec. 15, 2003 (JP) 2003-417351
Jan. 15, 2004 (JP) 2004-008331
Feb. 3, 2004 (JP) 2004-026383

(51) Int. Cl. C40B 30/04; C40B 60/12; C40B 40/08; C40B 40/12; C40B 50/18; C40B 99/00; C40B 40/10

(52) U.S. Cl. 506/9; 506/43; 506/39; 506/17; 506/18; 506/19; 506/32

(57) ABSTRACT

A biochip is provided that suppresses nonspecific adsorption or bonding of a detection target substance without coating with an adsorption inhibitor and that has excellent detection sensitivity. The constitution is such that it has a macromolecular substance containing a phosphorylcholine group and an active ester group on a substrate surface of a biochip substrate.

### TECHNICAL FIELD

The present invention relates to a biochip used for detection or analysis of a biologically active substance in a sample.

### BACKGROUND ART

Attempts to evaluate genetic activity and interpret biological processes such as disease processes and the biological process of the effect of a drug have traditionally been focused on genomics, but proteomics provides more detailed information about the biological function of a cell. Proteomics includes qualitative and quantitative measurements of genetic activity by detecting and quantifying expression at the protein level rather than at the gene level. It also includes research into phenomena that are not genetically coded, such as post-translational modification of proteins and interaction between proteins.

With an enormous amount of genomic information now available, there is a demand for proteomics research to be carried out at increasingly high speed and high efficiency (high throughput). As molecular arrays for this purpose, DNA chips have been put into practical use. With regard to the detection of proteins, which are the most complicated and diverse in terms of biological function, a protein chip has been proposed, and research has recently been advancing in this area. The protein chip referred to here is a generic term for a chip (micro substrate) on the surface of which a protein or a molecule for capturing the protein is immobilized.

However, since current protein chips have generally been developed as an extension of DNA chips, an investigation has been carried out into immobilization of a protein or a molecule for capturing the protein on a glass substrate as a chip surface (ref. for example, Patent Publication 1).

In detection of a signal from the protein chip, nonspecific adsorption of a detection target substance onto the protein chip substrate causes a decrease in the signal-to-noise ratio, thus degrading the detection accuracy (ref. for example, Non-Patent Publication 1).

Because of this, in a normal sandwich method, coating with an adsorption inhibitor is carried out in order to prevent nonspecific adsorption of secondary antibodies after primary antibodies have been immobilized, but the ability thereof to prevent nonspecific adsorption is not sufficient. Furthermore, there is the problem that, since coating with the adsorption inhibitor is carried out after the primary antibodies have been immobilized, the immobilized protein is coated with the adsorption inhibitor and cannot react with the secondary antibodies. Because of this, there has been a desire for a biochip for which the amount of nonspecific adsorption of a biologically active substance is suppressed, without coating with an adsorption inhibitor after the primary antibodies have been immobilized. There are various causes for nonspecific adsorption, and hydrophobic interaction, hydrogen bonding, et cetera, between a substrate material and a protein can be considered. Because of this, the surface of the biochip substrate is required to be hydrophilic and have no hydrogen-bonding group.

Moreover, in order to eliminate nonspecific adsorption of a detection target substance onto a protein chip substrate, a large number of washing processes with a surfactant are incorporated, but there is the problem that the surfactant might cause the coating film to peel off, and there is a demand for a protein chip having a coating film that is not peeled off by washing with a surfactant.

Furthermore, a technique for obtaining information about a test sample using a microarray chip is becoming an indispensable technique in biology and medicine. For example, in a DNA microarray, research into expression patterns of an entire genome is possible even in a complicated biological system, and the amount of genetic information has been increasing explosively.

In microarray signal detection, the background from a microarray substrate causes the S/N ratio to decrease, thus degrading the detection accuracy (for example, Non-Patent Publication 1, et cetera). The S/N ratio is a value obtained by dividing a signal level (signal) obtained from a labeled test sample by a signal level (noise) obtained from the labeled test sample but generated from a site other than a signal substance, and when the S/N ratio is high, the detection sensitivity is high.

When a fluorescent substance is used as a material that detects a substance on the microarray, the autofluorescence intensity of the microarray substrate becomes the background, and there is the problem that, when the autofluorescence of the substrate is high, the S/N ratio decreases. Furthermore, when the background becomes uneven due to a fluorescent substance becoming attached to the substrate, it might cause a problem in reproducibility or reliability of data obtained from the substrate.

The material used for a microarray substrate is often a glass or a plastic, and since the surfaces of these materials are usually chemically inactive, it is necessary to subject them to surface modification in order to immobilize a biologically active substance. Since it is difficult to directly incorporate various functional groups into the inactive surface of glass, plastic, et cetera, a method is generally employed in which an amino group is first incorporated, and a functional group is incorporated via the amino group.

As a method for incorporating an amino group into a substrate surface, there are a treatment with an aminoalkylsilane, a plasma treatment under a nitrogen atmosphere, coating with an amino group-containing macromolecular substance, et cetera, but from the viewpoint of ease of treatment, uniformity, and reproducibility, a treatment with an aminoalkylsilane is often used. Examples of the aminoalkylsilane generally used here include aminoalkylsilanes having a primary amino group such as aminopropyltrimethoxysilane, aminopropyltriethoxysilane, and aminopropylmethyldimethoxysilane.

As a method for incorporating a functional group via an amino group, there is known, for example, incorporating an aldehyde group into a substrate by treating with glutaraldehyde, which is a difunctional aldehyde (Patent Publication 2, Patent Publication 3, Patent Publication 4). When a maleimide group is incorporated, a treatment with N-(6-maleimidocaproyloxy)succinimide, et cetera, which is a crosslinking agent having a maleimide group at one end and an active ester at the other end (Patent Publication 5) may be carried out. In a similar manner, when an N-hydroxysuccinimide active ester is incorporated, ethyleneglycol-O,O-bis(succinimidylsuccinate), which has an active ester group at both ends, et cetera, may be used.

However, when the substrate is subjected to the above-mentioned surface treatment, the autofluorescence intensity of the substrate increases, and this increase in the autofluorescence of the substrate causes the S/N ratio to decrease. Furthermore, there is the problem that, due to a fluorescent substance becoming attached to the substrate, the background increases and causes the S/N ratio to decrease. Because of this, there is a desire for a microarray substrate for which the autofluorescence intensity is not increased by the surface treatment and a fluorescent substance does not become attached.

Furthermore, in one line of research into microarrays, a technique employing a micro channel, called microfluidics, has been developed with the aims of increasing the reaction efficiency and reducing the amount of sample. For example, an immunoassay in which an antigen-antibody reaction is made to occur within a micro channel (Patent Publication 6) can be cited. A method employing a micro channel has also been investigated in DNA analysis (Patent Publication 7).

However, in conventional analysis of a biologically active substance using a micro channel, the biologically active substance becomes attached to the channel, thus decreasing the detection sensitivity in some cases. Because of this, there is a desire for a technique that prevents the biologically active substance from becoming attached to the channel. Furthermore, in DNA hybridization, antigen-antibody reaction, et cetera, there is a strong desire for a system in which the reaction proceeds in a shorter time with small quantities.

Patent Publication 1: Japanese laid-open patent publication No. 2001-116750

### Non-Patent Publication 1: ‘DNA Microarray Application Manual’, Ed. by Y. Hayashisaki and K. Okazaki, Yodosha, 2000, p. 57

Patent Publication 2: Japanese laid-open patent publication No. 2002-176991
Patent Publication 3: Japanese laid-open patent publication No. 2002-181817
Patent Publication 4: Published Japanese translation No. 2002-532699 of a PCT application
Patent Publication 5: Japanese laid-open patent publication No. 11-187900
Patent Publication 6: Japanese laid-open patent publication No. 2001-004628
Patent Publication 7: Japanese laid-open patent application No. 2004-053417

### DISCLOSURE OF THE INVENTION

The present invention has been accomplished under the above-mentioned circumstances, and provides a biochip having excellent detection sensitivity, the biochip suppressing nonspecific adsorption or bonding of a detection target substance without coating with an adsorption inhibitor.

According to the present invention, there is provided a biochip substrate that includes, on the surface of a substrate, a macromolecular substance containing a first unit having a phosphorylcholine group and a second unit having an active ester group.

Since the biochip substrate of the present invention has a phosphorylcholine group, it is possible to suppress nonspecific adsorption of a biologically active substance onto the substrate. Furthermore, because of the active ester group, it is possible to stably incorporate into the macromolecular substance a capture substance that captures a biologically active substance. Because of this it is possible, without coating with an adsorption inhibitor, to suppress nonspecific adsorption or bonding of the detection target substance and improve the detection sensitivity. The biochip substrate of the present invention may be a substrate used for a biochip in which, for example, a capture substance for capturing a biologically active substance is immobilized on the surface of the substrate.

In the biochip substrate of the present invention, the macromolecular substance may contain a third unit having a butyl methacrylate group, and the proportion of the phosphorylcholine group contained in the macromolecular substance relative to the total of the phosphorylcholine group, the active ester group, and the butyl methacrylate group may be at least 3 mol % but not greater than 40 mol %. Furthermore, in the biochip substrate of the present invention, the macromolecular substance may contain a third unit having a butyl methacrylate group, and the proportion of the phosphorylcholine group contained in the macromolecular substance relative to the total of the phosphorylcholine group, the active ester group, and the butyl methacrylate group may be at least 20 mol % but less than 40 mol %.

In the biochip substrate of the present invention, the macromolecular substance may contain a third unit having a butyl methacrylate group, and the proportion of the active ester group contained in the macromolecular substance relative to the total of the phosphorylcholine group, the active ester group, and the butyl methacrylate group may be 1 mol % or more and 25 mol % or less. Furthermore, in the biochip substrate of the present invention, the macromolecular substance may contain a third unit having a butyl methacrylate group, and the proportion of the active ester group contained in the macromolecular substance relative to the total of the phosphorylcholine group, the active ester group, and the butyl methacrylate group may be at least 15 mol % but less than 25 mol %.

According to the present invention, there is provided a biochip substrate having, on the surface of a substrate, a macromolecular substance that includes components (a) and (b) below.

(a) a macromolecule that contains a first unit having a phosphorylcholine group and a second unit having an active ester group
(b) a macromolecule that contains a first unit having a phosphorylcholine group and a third unit having a butyl methacrylate group

Since the biochip substrate of the present invention has the above-mentioned macromolecular substance that includes the components (a) and (b), it is possible to more reliably suppress nonspecific adsorption of a biologically active substance onto the substrate. The first unit of component (a) and the first unit of component (b) may have the same structure or different structures. Furthermore, component (a) and component (b) may be mixed.

In the biochip substrate of the present invention, the proportion of the phosphorylcholine group contained in the macromolecular substance relative to the total of the phosphorylcholine group, the active ester group, and the butyl methacrylate group may be 3 mol % or more and 40 mol % or less. Furthermore, in the biochip substrate of the present invention, the proportion of the phosphorylcholine group contained in the macromolecular substance relative to the total of the phosphorylcholine group, the active ester group, and the butyl methacrylate group may be at least 20 mol % but less than 40 mol %. In the present specification, in the constitution in which the macromolecular substance includes the above-mentioned components (a) and (b), the proportion of the phosphorylcholine group means the total of the phosphorylcholine groups contained in component (a) and component (b).

In the biochip substrate of the present invention, the proportion of the active ester group contained in the macromolecular substance relative to the total of the phosphorylcholine group, the active ester group, and the butyl methacrylate group may be 1 mol % or more and 25 mol % or less. Furthermore, in the biochip substrate of the present invention, the proportion of the active ester group contained in the macromolecular substance relative to the total of the phosphorylcholine group, the active ester group, and the butyl methacrylate group may be at least 15 mol % but less than 25 mol %.

According to the present invention, there is provided a biochip substrate that includes, on the surface of a substrate,

a first layer that includes a compound having an amino group, and

a second layer that includes a macromolecular substance having a first unit containing a phosphorylcholine group and a second unit containing an active ester group,

the substrate, the first layer, and the second layer being layered in that order.

In the present invention, since the substrate, the first layer, and the second layer are layered in that order, it is possible to suppress nonspecific adsorption or bonding of a detection target substance without coating the surface of the biochip substrate with an adsorption inhibitor, thus improving the detection sensitivity. Furthermore, it is possible to suppress peel off of the layer caused by washing with a surfactant, et cetera. The first layer and the second layer may be formed in the form of a film.

In the biochip substrate of the present invention, the constitution may be such that the amino group of the first layer and the active ester group of the second layer react to form a covalent bond, specifically an amide bond.

In the biochip substrate of the present invention, the first layer may include a silane coupling agent having the amino group. The silane coupling agent having the amino group may be present in the form of an organosiloxane such as a polyorganosiloxane.

In the biochip substrate of the present invention, the constitution may be such that the first unit containing a phosphorylcholine group has a 2-methacryloyloxyethyl phosphorylcholine group.

In the biochip substrate of the present invention, the constitution may be such that the macromolecular substance has a third unit containing a butyl methacrylate group. Furthermore, in the present invention, the macromolecular substance may be a copolymer. In this constitution, the macromolecular substance may be a copolymer of a monomer having the phosphorylcholine group, a monomer having the active ester group, and a monomer having the butyl methacrylate group.

According to the present invention, there is provided a biochip substrate that includes

a first layer formed on a substrate, and

a second layer formed on the first layer,

the first layer being formed from a compound having at least one group selected from an acrylate group, a methacrylate group, a vinyl group, and an alkenyl group, and

the second layer being formed from a copolymer of a polymer of a monomer having a phosphorylcholine group and a monomer having an active ester group.

Furthermore, according to the present invention, there is provided a biochip substrate that includes

a substrate,

a first layer provided on the substrate and formed from an organosiloxane, and

a second layer provided on the first layer and formed from a copolymer of a monomer having a phosphorylcholine group and a monomer having an active ester group.

According to this constitution, since there is on the substrate the layer formed from a copolymer containing a phosphorylcholine group and an active ester group, it is possible to suppress nonspecific adsorption or bonding of a detection target substance without coating the surface of the biochip substrate with an adsorption inhibitor, thus improving the detection sensitivity. Furthermore, it is possible to suppress peel off of the layer caused by washing with a surfactant, et cetera. In this constitution, the first layer may be provided on the surface of the substrate, and the second layer may be provided on the surface of the first layer.

Moreover, the organosiloxane may be a compound having a group containing a polymerizable double bond. The group having a polymerizable double bond may constitute an alkenyl group. Furthermore, at least some of the groups having a polymerizable double bond may constitute at least one group selected from an acrylate group, a methacrylate group, a vinyl group, and an alkenyl group.

In the biochip substrate of the present invention, at least one group, selected from an acrylate group, a methacrylate group, a vinyl group, and an alkenyl group, of the compound may form a covalent bond with the copolymer of the second layer.

In the biochip substrate of the present invention, the first layer may be formed from a silane coupling agent having at least one group selected from an acrylate group, a methacrylate group, a vinyl group, and an alkenyl group. Furthermore, the silane coupling agent may form an organosiloxane.

In the biochip substrate of the present invention, the constitution may be such that the monomer having a phosphorylcholine group has a methacrylic group or an acrylic group. Furthermore, in the biochip substrate of the present invention, the monomer having a phosphorylcholine group may be 2-methacryloyloxyethyl phosphorylcholine.

In the biochip substrate of the present invention, the constitution may be such that the monomer having an active ester group has a methacrylic group or an acrylic group. Furthermore, in the biochip substrate of the present invention, the active ester group may include a p-nitrophenyl group or an N-hydroxysuccinimide group.

In the biochip substrate of the present invention, the material for the substrate may be a plastic. Furthermore, in the biochip substrate of the present invention, the plastic may be a saturated cyclic polyolefin. Moreover, in the biochip substrate of the present invention, the material for the substrate may be a glass.

According to the present invention, there is provided a biochip substrate having, on the surface of a substrate, a macromolecular substance having a first unit containing a phosphorylcholine group and a second unit containing a monovalent group represented by formula (1) below.

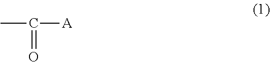

(In formula (1) above, A is a monovalent leaving group other than a hydroxyl group.)

Furthermore, according to the present invention, there is provided a biochip substrate having, on the surface of a substrate, a macromolecular substance that includes components (a) and (b) below.

(a) a macromolecule that contains a first unit having a phosphorylcholine group and a second unit having a monovalent group represented by formula (1) above
(b) a macromolecule that contains a first unit having a phosphorylcholine group and a third unit having a butyl methacrylate group

Furthermore, according to the present invention, there is provided a biochip substrate that includes

a substrate,

a first layer provided on the substrate and including a compound having an amino group, and

a second layer provided on the first layer and including a macromolecular substance that contains a first unit having a phosphorylcholine group and a second unit having a monovalent group represented by formula (1) above.

Furthermore, according to the present invention, there is provided a biochip substrate that includes

a substrate,

a first layer provided on the substrate and formed from a compound having at least one group selected from an acrylate group, a methacrylate group, a vinyl group, and an alkenyl group, and

a second layer provided on the first layer and formed from a copolymer of a polymer of a monomer having a phosphorylcholine group and a monomer having a monovalent group represented by formula (1) above.

According to this constitution, since the leaving group A is present on the second unit via a carbonyl group, as shown in formula (1) above, it is possible to more reliably chemically incorporate into the macromolecular substance a capture substance for capturing a biologically active substance.

In the biochip substrate of the present invention, the monovalent group represented by formula (1) above may be any group selected from formula (p) and formula (q) below. It is thereby possible to more reliably activate the leaving group A and further improve the reactivity. Formula (p) and formula (q) below may have a constitution in which H is removed from N in an N-containing cyclic compound and a constitution in which H is removed from C in a C-containing cyclic compound respectively.

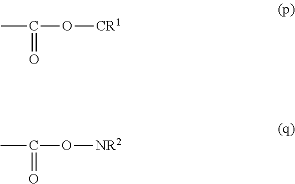

(In formula (p) and formula (q) above, R¹ and R² independently denote a monovalent organic group and may be any of a straight chain, a branched chain, and a cyclic chain. Furthermore, in formula (p) above, R¹ may be a divalent group that, together with C, forms a ring. Moreover, in formula (q) above, R² may be a divalent group that, together with N, forms a ring.)

According to the present invention, there is provided a biochip substrate having, on the surface of a substrate, a macromolecular substance having a first unit containing a phosphorylcholine group and a second unit containing a carboxylic acid derivative group.

Furthermore, according to the present invention, there is provided a biochip substrate having, on the surface of a substrate, a macromolecular substance that includes components (a) and (b) below.

(a) a macromolecule that contains a first unit having a phosphorylcholine group and a second unit having a carboxylic acid derivative group
(b) a macromolecule that contains a first unit having a phosphorylcholine group and a third unit having a butyl methacrylate group

Furthermore, according to the present invention, there is provided a biochip substrate that includes

a substrate,

a first layer provided on the substrate and including a compound having an amino group, and

a second layer provided on the first layer and including a macromolecular substance having a first unit containing a phosphorylcholine group and a second unit containing a carboxylic acid derivative group.

Moreover, according to the present invention, there is provided a biochip substrate that includes

a substrate,

a first layer provided on the substrate and formed from a compound having at least one group selected from an acrylate group, a methacrylate group, a vinyl group, and an alkenyl group, and

a second layer provided on the first layer and formed from a copolymer of a monomer having a phosphorylcholine group and a monomer having a carboxylic acid derivative group.

According to the present invention, there is provided a microarray substrate that includes, immobilized on the surface of the substrate of the aforementioned biochip substrate, a capture substance for capturing a biologically active substance and that detects the biologically active substance using a fluorescent dye, wherein the microarray substrate includes on the surface of the substrate the macromolecular substance that contains a first unit having a phosphorylcholine group and a second unit having an active ester group. Since the microarray substrate of the present invention can form a covalent bond by reacting the capture substance and the active ester group while suppressing nonspecific adsorption of the biologically active substance, it is possible to reliably carry out detection of the biologically active substance.

According to the present invention, there is provided a biochip that includes, immobilized on the biochip substrate, a capture substance for capturing a biologically active substance. The capture substance may have biological activity. Furthermore, it may be a molecule having a biologically active substance. This molecule may capture a biologically active substance by itself, or a plurality of the molecules may capture a biologically active substance. Moreover, in the present invention, the constitution may be such that the capture substance is covalently bonded to a macromolecular substance.

According to the present invention, there is provided a biochip that includes a substrate having on its surface a macromolecular substance having a first unit containing a phosphorylcholine group and a second unit containing an active ester group,

wherein the active ester group and a capture substance for capturing a biologically active substance react to form a covalent bond.

According to the present invention, since by the action of the active ester group the capture substance is chemically immobilized on the macromolecular substance, and nonspecific adsorption of a biologically active substance onto the substrate is suppressed by the action of the phosphorylcholine group, it is possible to reliably carry out analysis of the biologically active substance. With regard to the constitution in which a covalent bond is formed by reaction with the capture substance, a case in which the capture substance and a predetermined site of the active ester group react to form a covalent bond is included. Furthermore, in the present invention, the macromolecular substance may be formed in the form of a layer on the surface of the substrate. Moreover, the surface of the substrate may be covered with the macromolecular substance. It is thereby possible to more reliably suppress nonspecific adsorption. Furthermore, it is possible to more reliably incorporate into the surface of the substrate the active ester group used for immobilization.

According to the present invention, there is provided a biochip having on the surface of a substrate a macromolecular substance that contains a first unit having a phosphorylcholine group and a plurality of second units having an active ester group,

wherein some of the active ester groups and a capture substance for capturing a biologically active substance react to form a covalent bond, and

the remainder of the active ester groups and a hydrophilic polymer having a hydrophilic group react to form a covalent bond.

In the present invention, the macromolecular substance contains, for example, two or more active ester groups of a single type, and the remaining active ester groups other than the active ester groups that have formed a covalent bond with the capture substance react with the hydrophilic polymer to form a covalent bond. Because of this, reaction of the biologically active substance with the active ester group is suppressed, and the macromolecular substance is made hydrophilic. The constitution is therefore such that nonspecific adsorption of the biologically active substance is yet further suppressed.

In the biochip of the present invention, the constitution may be such that the hydrophilic polymer has an amino group. It is thereby possible to more reliably react the hydrophilic polymer with the active ester to thus form an amide bond.

In the biochip of the present invention, the hydrophilic polymer may contain in its structure a polyalkylene oxide or a plurality of types of the polyalkylene oxide. Furthermore, the hydrophilic polymer may contain in its structure any one of polyethylene oxide, polypropylene oxide, a copolymer thereof, and a copolymer of at least one thereof and another polyalkylene oxide.

In the biochip of the present invention, the material for the substrate may be a plastic. Furthermore, in the biochip of the present invention the plastic may be a saturated cyclic polyolefin.

According to the present invention, there is provided a biochip that includes

a substrate,

a channel provided on the substrate, and

a macromolecular substance on the surface of the channel, the macromolecular substance containing a first unit having a phosphorylcholine group and a second unit having an active ester group,

the active ester group and a capture substance for capturing a biologically active substance reacting to form a covalent bond.

In the biochip of the present invention, since the channel is provided on the substrate, the constitution is such that the capture substance is more fully immobilized. Furthermore, the constitution is such that the biologically active substance can be made to interact more reliably with the capture substance. Because of this, it can be used desirably for detection or quantification of a biologically active substance in a test liquid, the biologically active substance having been captured on the capture substance, by making the test liquid flow through the channel. Furthermore, it may be used for the identification of a component contained in the test liquid. In this constitution, the channel may be provided on the surface of the substrate in the form of a groove.

The biochip of the present invention may have a plurality of the active ester groups, and the plurality of active ester groups may react with the capture substance to form a covalent bond, or may be deactivated. The active ester group being deactivated means a group (leaving group) constituting part of the active ester group is substituted by another group, and high reactivity is lost.

The biochip of the present invention may have a protecting member covering the channel. Furthermore, the protecting member may be a plate-form member. The constitution here may be such that the substrate and the plate-form protecting member are joined, and the channel is formed on the joined faces.

In the biochip of the present invention, the material for the substrate or the protecting member may be a plastic. Furthermore, in the biochip of the present invention, the material for the substrate may be a plastic that is transparent to detection light. Moreover, in the present invention, the material for at least one of the substrate and the protecting member may be a plastic that is transparent to detection light.

In the biochip of the present invention, the constitution may further be such that the biologically active substance is captured by the capture substance.

In the biochip of the present invention, the first unit containing a phosphorylcholine group may have a 2-methacryloyloxyethyl phosphorylcholine group.

In the biochip of the present invention, the active ester group may have a p-nitrophenyl group or an N-hydroxysuccinimide group.

In the biochip of the present invention, the macromolecular substance may have a third unit containing a butyl methacrylate group. In this constitution, the macromolecular substance may be a copolymer of a monomer having the phosphorylcholine group, a monomer having the active ester group, and a monomer having the butyl methacrylate group.

In the biochip of the present invention biochip, the material for the substrate may be a glass.

In the biochip of the present invention, the capture substance may be one or more materials selected from the group consisting of a nucleic acid, an aptamer, a protein, an enzyme, an antibody, an oligopeptide, a sugar chain, and a glycoprotein. Furthermore, in the biochip of the present invention, the biologically active substance may be one or more materials selected from the group consisting of a nucleic acid, an aptamer, a protein, an enzyme, an antibody, an oligopeptide, a sugar chain, and a glycoprotein.

In the biochip of the present invention, the constitution may be such that a capture substance for capturing a biologically active substance is immobilized on the surface of the substrate under neutral or alkaline conditions. The neutral or alkaline conditions may be conditions of the pH being equal to or greater than 7.6.

According to the present invention, there is provided a biochip that includes a substrate having on its surface a macromolecular substance having a first unit containing a phosphorylcholine group and a second unit containing a monovalent group represented by formula (1),

wherein the monovalent group represented by formula (1) below and a capture substance for capturing a biologically active substance react to form a covalent bond.

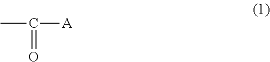

(In formula (1) above, A is a monovalent leaving group other than a hydroxyl group.)

Furthermore, according to the present invention, there is provided a biochip having on the surface of a substrate a macromolecular substance that contains a first unit having a phosphorylcholine group and a plurality of second units having a monovalent group represented by formula (1) above,

wherein some of the monovalent groups represented by formula (1) and a capture substance for capturing a biologically active substance react to form a covalent bond, and

the remainder of the monovalent groups represented by formula (1) and a hydrophilic polymer having a hydrophilic group react to form a covalent bond.

Moreover, according to the present invention, there is provided a biochip that includes

a substrate

a channel provided on the substrate and, on the surface of the channel,

a macromolecular substance that contains a first unit having a phosphorylcholine group and a second unit having a monovalent group represented by formula (1) above,

the active ester group and a capture substance for capturing a biologically active substance reacting to form a covalent bond.

In the biochip of the present invention, the monovalent group represented by formula (1) may be any group selected from formula (p) and formula (q) below.

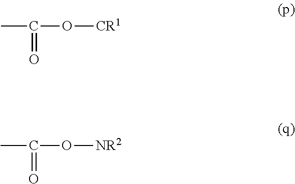

(In formula (p) and formula (q) above, R¹ and R² independently denote a monovalent organic group, and may be any one of a straight chain, a branched chain, and a cyclic chain. Furthermore, in formula (p) above, R¹ may be a divalent group that, together with C, forms a ring. Moreover, in formula (q) above, R² may be a divalent group that, together with N, forms a ring.)

According to the present invention, there is provided a biochip that includes a substrate having on its surface a macromolecular substance having a first unit containing a phosphorylcholine group and a second unit containing a carboxylic acid derivative group, wherein the carboxylic acid derivative group and a capture substance for capturing a biologically active substance react to form a covalent bond.

Furthermore, according to the present invention, there is provided a biochip having on the surface of a substrate a macromolecular substance that contains a first unit having a phosphorylcholine group and a plurality of second units having a carboxylic acid derivative group,

wherein some of the carboxylic acid derivative groups and a capture substance for capturing a biologically active substance react to form a covalent bond, and

the remainder of the carboxylic acid derivative groups and a hydrophilic polymer having a hydrophilic group react to form a covalent bond.

Moreover, according to the present invention, there is provided a biochip that includes

a substrate,

a channel provided on the substrate and, on the surface of the channel,

a macromolecular substance that contains a first unit having a phosphorylcholine group and a second unit having a carboxylic acid derivative group,

the active ester group and a capture substance for capturing a biologically active substance reacting to form a covalent bond.

According to the present invention, there is provided a microarray that includes, immobilized on the aforementioned microarray substrate

one or more of the capture substances selected from the group consisting of a nucleic acid, an aptamer, a protein, an enzyme, an antibody, an oligopeptide, a sugar chain, and a glycoprotein.

According to the present invention, it is possible to precisely detect a signal from a sample of the microarray by reducing autofluorescence of the microarray substrate and reducing adsorption of the fluorescent substance.

According to the present invention, there is provided a process for producing the biochip substrate, the process including

(1) contacting the surface of the substrate with the compound having an amino group, and
(2) contacting the compound having an amino group with the macromolecular substance.

Furthermore, according to the present invention, there is provided a process for producing the biochip substrate, the process including

forming the first layer on the substrate, and then

forming the second layer by copolymerizing on the first layer the monomer having a phosphorylcholine group and the monomer having an active ester group.

According to the present invention, there is provided a method for using the biochip substrate, the method including

(1) immobilizing on the substrate under neutral or alkaline conditions a capture substance for capturing a biologically active substance, and
(2) contacting the surface of the microchip substrate with a liquid containing a biologically active substance to be detected and having a pH equal to or less than the above-mentioned conditions so as to allow the capture substance to capture the biologically active substance.

In accordance with the method for using a biochip substrate of the present invention, by controlling the pH of the solution of the biologically active substance, it is possible to suppress nonspecific adsorption or bonding of a detection target substance without coating with an adsorption inhibitor, thus giving a microchip having high detection sensitivity. In this constitution, the liquid may be a solution containing a biologically active substance. Furthermore, the conditions for (1) above may be a pH of, for example, 7.6.

In the method for using a biochip substrate of the present invention, the capture substance may be one or more materials selected from the group consisting of a nucleic acid, an aptamer, a protein, an enzyme, an antibody, an oligopeptide, a sugar chain, and a glycoprotein.

Moreover, in the method for using a biochip substrate of the present invention, the biologically active substance to be detected may be one or more materials selected from the group consisting of a nucleic acid, an aptamer, a protein, an enzyme, an antibody, an oligopeptide, a sugar chain, and a glycoprotein.

According to the present invention, there is provided a process for producing a biochip using the biochip substrate,

the biochip substrate having a plurality of the active ester groups, the process including

reacting some of the active ester groups with the capture substance to immobilize the capture substance, and

deactivating the remainder of the active ester groups after the immobilization of the capture substance.

In the process for producing a biochip of the present invention, the deactivation of the remainder of the active ester groups may be carried out using an alkaline compound.

Furthermore, in the process for producing a biochip of the present invention, the deactivation of the remainder of the active ester groups may be carried out using a compound having a primary amino group. Moreover, in the process for producing a biochip of the present invention, the compound having a primary amino group may be aminoethanol or glycine.

In the process for producing a biochip of the present invention, the capture substance may be one or more materials selected from the group consisting of a nucleic acid, an aptamer, a protein, an enzyme, an antibody, an oligopeptide, a sugar chain, and a glycoprotein. Furthermore, in this constitution, the immobilization of the capture substance may include contacting the surface of the substrate with a solution containing the biologically active substance and having a pH of equal to or less than 7.6.

According to the present invention, there is provided a process for producing the biochip of the present invention, the process including contacting the surface of the substrate with an acidic or neutral liquid containing the capture substance. In the present invention, the acidic or neutral liquid may have a pH of equal to or less than 7.6.

According to the present invention, there is provided a process for producing the aforementioned biochip, the process including reacting some of the active ester groups of the biochip substrate and the capture substance to form a covalent bond, thus immobilizing the capture substance, and

reacting the remainder of the active ester groups and the hydrophilic polymer to form a covalent bond after the immobilization of the capture substance.

According to the present invention, there is provided a biochip produced by the process for producing a biochip.

### BRIEF DESCRIPTION OF THE DRAWINGS

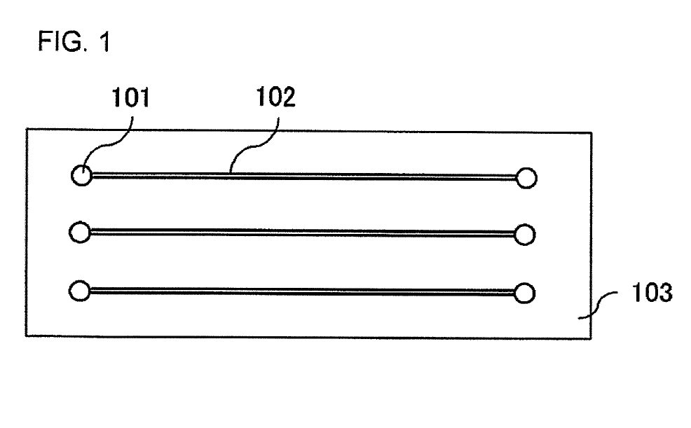

The above-mentioned object, other objects, features, and advantages will be more apparent from preferred embodiments described below and an accompanying drawing.

[FIG. 1] A plan view showing the constitution of a biochip related to an embodiment.

### BEST MODE FOR CARRYING OUT THE INVENTION

### First Embodiment

The present embodiment relates to a biochip substrate having, immobilized on a substrate (solid phase substrate), a capture substance for capturing a biologically active substance. This biochip substrate has a macromolecular substance on the surface of the substrate. The macromolecular substance has a first unit containing a phosphorylcholine group and a second unit containing a carboxylic acid derivative group. The constituent members of the biochip substrate are explained below.

### Macromolecular Substance

The macromolecular substance having the first unit containing a phosphorylcholine group and the second unit containing a carboxylic acid derivative group is a polymer having both the property of suppressing nonspecific adsorption of a biologically active substance and the property of immobilizing a biologically active substance. The phosphorylcholine group contained in the first unit plays a role in suppressing the nonspecific adsorption of a biologically active substance, and the carboxylic acid derivative group contained in the second unit plays a role in chemically immobilizing a capture molecule.

The constitution may be such that the first unit has, for example, a group such as a (meth)acryloyloxyalkyl phosphorylcholine group such as a 2-methacryloyloxyethyl phosphorylcholine group or a 6-methacryloyloxyhexyl phosphorylcholine group;

a (meth)acryloyloxyalkoxyalkyl phosphorylcholine group such as a 2-methacryloyloxyethoxyethyl phosphorylcholine group or a 10-methacryloyloxyethoxynonyl phosphorylcholine group;

or an alkenyl phosphorylcholine group such as an allyl phosphorylcholine group, a butenyl phosphorylcholine group, a hexenyl phosphorylcholine group, an octenyl phosphorylcholine group, or a decenyl phosphorylcholine group; and the phosphorylcholine group is contained in these groups.

Furthermore, among these groups, 2-methacryloyloxyethyl phosphorylcholine is preferable. In accordance with the constitution in which the first unit has 2-methacryloyloxyethyl phosphorylcholine, it is possible to yet more reliably suppress nonspecific adsorption on the surface of the substrate.

An activated carboxylic acid derivative is one in which the carboxyl group of the carboxylic acid is activated, and is a carboxylic acid having a leaving group via C═O. Examples of the activated carboxylic acid derivative include compounds in which the carboxyl group of a carboxylic acid, such as acrylic acid, methacrylic acid, crotonic acid, maleic acid, or fumaric acid, is converted into an acid anhydride, an acid halide, an active ester, or an activated amide. The carboxylic acid derivative group is an activated group originating from these compounds, and may have a group such as, for example, an active ester group such as a p-nitrophenyl group or an N-hydroxysuccinimide group; or a halogen such as —Cl or —F.

Furthermore, the carboxylic acid derivative group may be a group represented by formula (1) below.

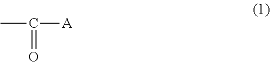

(In formula (1) above, A is a leaving group other than a hydroxyl group.)

The monovalent group represented by formula (1) above may be any group selected from formula (p) and formula (q).

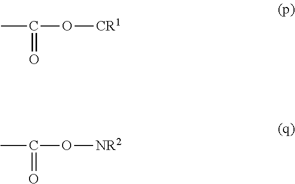

(In formula (p) and formula (q) above, R¹ and R² independently denote a monovalent organic group, and may be any one of a straight chain, a branched chain, and a cyclic chain. Furthermore, in formula (p) above, R¹ may be a divalent group that, together with C, forms a ring. Moreover, in formula (q) above, R² may be a divalent group that, together with N, forms a ring.)

Examples of the group represented by formula (p) above include groups represented by formulae (r), (s), and (w) below. Furthermore, examples of the group represented by formula (q) above include groups represented by formulae (u) and (v).

Examples of the group represented by formula (1) above may include a group derived from an acid anhydride represented by formula (r) or formula (s) below;

a group derived from an acid halide represented by formula (t) below;
a group derived from an active ester represented by formula (u) or formula (w) below; and
a group derived from an activated amide represented by formula (v) below.

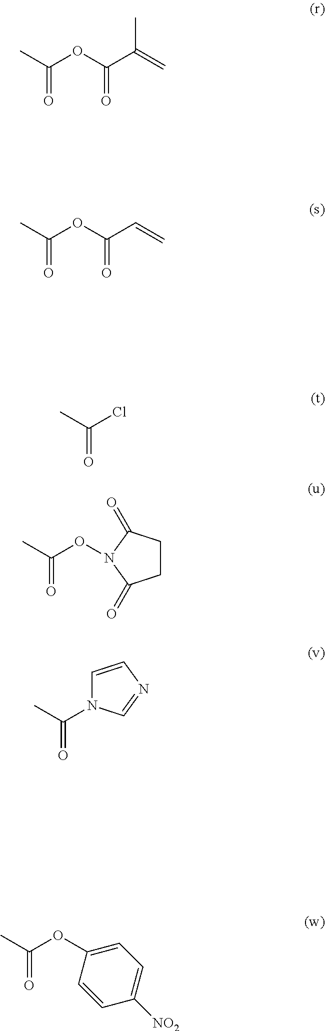

Among the carboxylic acid derivative groups, the active ester group is preferably used due to excellent reactivity under mild conditions. The mild conditions are, for example, neutral or alkaline conditions, and specifically the pH is 7.0 or more and 10.0 or less, more specifically is 7.6 or more and 9.0 or less, and yet more specifically is 8.0.

The definition of the ‘active ester group’ referred to in the present specification is not strictly specified, but is commonly used as a normal technical expression in various types of chemical synthesis fields such as macromolecular chemistry and peptide synthesis, with the meaning of a group of esters that have an electron-withdrawing group having high acidity on the alcohol side of the ester group and activate a nucleophilic reaction, that is, a highly reactive ester group. In practice, phenol esters, thiophenol esters, N-hydroxyamine esters, esters of heterocyclic hydroxyl compounds, et cetera, are known as active ester groups that have much higher activity than alkyl esters or the like.

In the present embodiment and the embodiments below, a case in which the activated carboxylic acid derivative in the macromolecular substance is an active ester group is explained. Examples of the active ester group include a p-nitrophenyl group, an N-hydroxysuccinimide group, a succinimide group, a phthalimide group, and 5-norbornene-2,3-dicarboximide group or the like and, for example, the p-nitrophenyl group is preferably used.

In the case of the biochip substrate that includes a capture substance immobilized on the surface of the substrate, as a more specific combination of the first unit and the second unit, for example, the constitution may be such that the first unit containing a phosphorylcholine group has a 2-methacryloyloxyethyl phosphorylcholine group and the active ester group is a p-nitrophenyl group.

Furthermore, the macromolecular substance used in the present invention may include another group in addition to the phosphorylcholine group and the carboxylic acid derivative group. Moreover, the macromolecular substance may be a copolymer. Specifically, the macromolecular substance is preferably a copolymer containing a butyl methacrylate group. It is thereby possible to make the macromolecular substance appropriately hydrophobic and further desirably ensure that there is adsorbability onto the surface of the substrate.

Specifically, the macromolecular substance may be a copolymer of a first monomer having a 2-methacryloyloxyethyl phosphorylcholine (MPC) group, a second monomer having a p-nitrophenylcarbonyloxyethyl methacrylate (NPMA) group, and a third monomer having a butyl methacrylate (BMA) group. Poly(MPC-co-BMZ-co-NPMZ) (PMBN), which is a copolymer of these monomers, is schematically shown by formula (2) below.

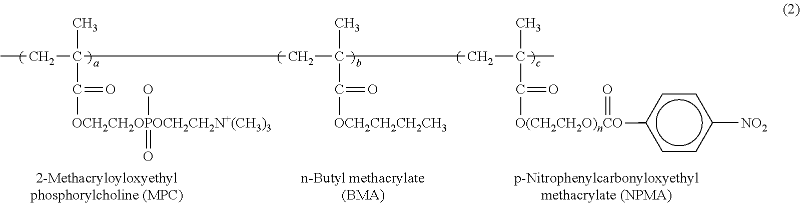

In formula (2) above, a, b, and c are independently a positive integer. Furthermore, in formula (2) above, the first to third monomers may be block-copolymerized, or these monomers may be random-copolymerized.

Copolymers represented by formula (2) above have a still more excellent constitution because of the balance between making the macromolecular substance appropriately hydrophobic, the property of suppressing nonspecific adsorption, and the property of immobilizing a capture substance. Because of this, in accordance with the use thereof, it is possible to yet more reliably cover the surface of the substrate with the macromolecular substance, and to more reliably immobilize a capture substance by a covalent bond so as to incorporate it into the substrate having the macromolecular substance provided thereon while suppressing nonspecific adsorption onto the substrate.

The copolymer represented by formula (2) above may be obtained by mixing monomers such as MPC, BMA, and NPMA and subjecting them to a known polymerization method such as radical polymerization. When the copolymer represented by formula (2) above is prepared by radical polymerization, solution polymerization may, for example, be carried out in an atmosphere of an inert gas such as Ar under temperature conditions of 30° C. or higher and 90° C. or lower.

A solvent used in the solution polymerization may be selected as appropriate and, for example, an organic solvent such as an alcohol such as methanol, ethanol, or isopropanol, an ether such as diethyl ether, or chloroform may be used singly or as a mixture of a plurality thereof. Specifically, a mixed solvent containing diethyl ether and chloroform at 8:2 as a ratio by volume may be used.

Furthermore, as a radical polymerization initiator used in a radical polymerization reaction, a normally used initiator may be used. Examples thereof include azo type initiators such as azobisisobutyronitrile (AIBN) and azobisvaleronitrile; and oil-soluble organic peroxides such as lauroyl peroxide, benzoyl peroxide, t-butylperoxyneodecanoate, and t-butylperoxypivalate.

More specifically, polymerization may be carried out using a mixed solvent of diethyl ether and chloroform at 8:2 as a ratio by volume and AIBN in Ar at 60° C. for on the order of 2 to 6 hours.

### Substrate Material

In the present embodiment, the material for a substrate used as the biochip substrate may be, for example, a glass, a plastic, a metal, or other. Among these, from the viewpoint of ease of surface treatment and mass productivity, a plastic is preferable, and a thermoplastic resin is more preferable.

As the thermoplastic resin, those having a low level of fluorescence emission may be used. By the use of a resin having a low level of fluorescence emission, since the background in a detection reaction of a biologically active substance can be reduced, it is possible to further improve the detection sensitivity. Examples of thermoplastic resins having a low level of fluorescence emission include straight-chain polyolefins such as polyethylene and polypropylene;

cyclic polyolefins; and
fluorine-containing resins; or the like. Among these resins, saturated cyclic polyolefins are suitable for optical analysis due to particularly excellent heat resistance, chemical resistance, low fluorescence, transparency, and moldability, and are preferably used as a material for the substrate.

The saturated cyclic polyolefin referred to here means a saturated polymer obtained by hydrogenating a homopolymer having a cyclic olefin structure or a copolymer of a cyclic olefin and an α-olefin. Examples of the former include saturated polymers produced by hydrogenating a polymer obtained by ring-opening polymerization of, for example, a norbornene-based monomer represented by norbornene, dicyclopentadiene, or tetracyclododecene, or an alkyl substituted derivative thereof. The latter copolymers are saturated polymers produced by hydrogenating a random copolymer of a cyclic olefinic monomer and an α-olefin such as ethylene, propylene, isopropylene, 1-butene, 3-methyl-1-butene, 1-pentene, 3-methyl-1-pentene, 1-hexene, or 1-octene. Among the copolymers, a copolymer with ethylene is most preferable. These resins may be used singly or as a copolymer or a mixture of two or more types. Furthermore, it is possible to use not only a saturated cyclic polyolefin obtained by ring-opening polymerization of a monomer having a cyclic olefin structure but also a saturated cyclic polyolefin obtained by addition polymerization of a monomer having a cyclic olefin structure.

The biochip substrate related to in the present embodiment is obtained by coating the surface of a substrate processed into a predetermined shape with a liquid containing a macromolecular substance, and drying it. Furthermore, a substrate may be immersed in a liquid containing a macromolecular substance and dried.

In the present embodiment and the embodiments below, the shape of the substrate is not limited to a plate, and may be a film or a sheet. Specifically, the substrate may be a flexible plastic film. Furthermore, the substrate may be constituted from one member or may be constituted from a plurality of members.

A biochip may be produced using the biochip substrate thus obtained. The biochip employing the biochip substrate is explained below.

The biochip may be constituted so that a capture substance for capturing a biologically active substance is immobilized on the surface of the biochip substrate via a macromolecular substance. It can thereby be used more suitably for detection of the biologically active substance.

In the present embodiment and the embodiments hereafter, the biochip may be used singly or in a state in which it is incorporated into another analytical device. For example, the constitution may be such that the biochip also functions as a sample stage of an analytical device.

In the present embodiment and the embodiments below, the capture substance for capturing a biologically active substance may be a material that specifically interacts with the biologically active substance. The specific interaction may be a physical interaction or a chemical interaction. Furthermore, the capture substance may have biological activity. Examples of the capture substance having biological activity include a nucleic acid, an aptamer, a protein, an enzyme, an antibody, an oligopeptide, a sugar chain, and a glycoprotein.

Furthermore, in the present embodiment and the embodiments below, the biologically active substance may be, for example, a nucleic acid, an aptamer, a protein, an enzyme, an antibody, an oligopeptide, a sugar chain, or a glycoprotein.

A process for producing the biochip is now explained. The biochip of the present embodiment is obtained by immobilizing a capture substance on the biochip substrate.

### Immobilization of Capture Substance for Capturing Biologically Active Substance

Production of a biochip may involve, for example,

(i) immobilizing a biochip substrate capture substance by reacting the capture substance with at least some active ester groups among a plurality of active ester groups contained in a macromolecular substance on the biochip substrate so as to form a covalent bond, and
(ii) deactivating active ester groups of the substrate surface other than those with which the capture substance has been immobilized, that is, deactivating the remainder of the active ester groups. Procedures thereof are explained below.

In the above-mentioned (i), when immobilizing the capture substance for capturing a biologically active substance on the biochip substrate, it is preferable to employ a method in which a liquid in which the capture substance is dissolved or dispersed is spotted. Some of the active ester groups contained in the macromolecular substance react with the capture substance to thus form a covalent bond with the capture substance.

The pH of the liquid in which the capture substance is dissolved or dispersed is, for example, acidic to neutral.

Furthermore, after spotting, in order to remove biologically active substance that has not been immobilized, washing may be carried out with pure water or a buffer solution.

Moreover, as shown in the above-mentioned (ii), after washing, a treatment to deactivate active esters of the substrate surface other than those with which the biologically active substance is immobilized is carried out using an alkaline compound or a compound having a primary amino group.

As the alkaline compound, sodium hydroxide, potassium hydroxide, sodium carbonate, sodium hydrogen carbonate, disodium hydrogen phosphate, calcium hydroxide, magnesium hydroxide, sodium borate, lithium hydroxide, potassium phosphate, et cetera, may be used.

As the compound having a primary amino group, glycine, 9-aminoaquazine, aminobutanol, 4-aminobutyric acid, aminocapric acid, aminoethanol, 5-amino 2,3-dihydro-1,4-pentanol, aminoethanethiol hydrochloride, aminoethanethiol sulfate, 2-(2-aminoethylamino)ethanol, dihydrogen 2-aminoethyl phosphate, hydrogen aminoethyl sulfate, 4-(2-aminoethyl)morpholine, 5-aminofluorescein, 6-aminohexanoic acid, aminohexyl cellulose, p-aminohippuric acid, 2-amino-2-hydroxymethyl-1,3-propanediol, 5-aminoisophthalic acid, aminomethane, aminophenol, 2-aminooctane, 2-aminooctanoic acid, 1-amino 2-propanol, 3-amino-1-propanol, 3-aminopropene, 3-aminopropionitrile, aminopyridine, 11-aminoundecanoic acid, aminosalicylic acid, aminoquinoline, 4-aminophthalonitrile, 3-aminophthalimide, p-aminopropiophenone, aminophenylacetic acid, aminonaphthalene, et cetera, may be used. Among these, it is preferable to use aminoethanol or glycine.

In order to enhance reactivity with the active ester group, the capture substance that is to be immobilized on the biochip substrate preferably has an amino group. Since the amino group has excellent reactivity with the active ester group, by the use of a capture substance having an amino group, it is possible to efficiently and strongly immobilize the capture substance on the biochip substrate. The position at which the amino group is incorporated may be a molecular chain terminal or side chain, but it is preferable that it is incorporated at the molecular chain terminal.

For example, when a nucleic acid or an aptamer is used as the capture substance to be immobilized on the biochip substrate described in the present embodiment and the embodiments below, in order to enhance the reactivity with the active ester group it is preferable to incorporate an amino group. In the case of a nucleic acid chain such as DNA or an aptamer, although an amino group is present in the molecular chain, a further amino group may be incorporated into the molecular chain terminal. It is thereby possible to react the terminal amino group with the active ester group to thus more reliably form a covalent bond with the macromolecular substance. Moreover, by the use of a terminal amino group for immobilization, it is possible to yet more efficiently carry out hybridization with a DNA complementary strand or a mutual reaction with a protein.

Furthermore, when a protein, an enzyme, an antibody, an oligopeptide, a sugar chain, or a glycoprotein is used as the capture substance, it is preferable to incorporate an amino group as necessary.

According to the above, a biochip having a capture substance immobilized on a substrate is obtained. This biochip may be used for detection, quantification, et cetera, of a biologically active substance. Furthermore, it may be used for identification of a biologically active substance contained in a test liquid. Detection of a biologically active substance using the biochip is explained below.

### Detection of Biologically Active Substance

A detection method for a biologically active substance using the biochip is not particularly limited but it may be carried out using, for example, a fluorescent substance. The detection sensitivity can thereby be improved.

Furthermore, when an active ester group is used on the biochip without deactivating it, or when there is a possibility that an active ester group might remain on the substrate, a liquid in which a biologically active substance, which is a detection target, is dissolved or dispersed may be made neural to acidic. It is thereby possible to yet more reliably suppress nonspecific reaction or adsorption of the biologically active substance with the macromolecular substance.

As such conditions, specifically, the pH of the liquid may be equal to or less than 8.0, and may preferably be equal to or less than 7.6. Furthermore, more specifically, the pH may be, for example, 7.0. If the pH is too high, the active ester group and the amino group of the biologically active substance react with each other, and the biologically active substance to be detected is easily immobilized via a covalent bond in an area other than that on which a capture molecule is spotted.

According to the present embodiment, since it is possible to suppress nonspecific adsorption or bonding of a detection target substance without coating the surface of the biochip substrate with an adsorption inhibitor, and more reliably immobilize a capture molecule for capturing a biologically active substance via a covalent bond, the detection sensitivity and the detection accuracy can be improved.

The biochip of the present embodiment is used, for example, for parallel detection and analysis of a large number of proteins, nucleic acids, et cetera, in a biological sample. In further detail, for example, it is used for measurement, et cetera, of proteomics or genetic activity at the intracellular protein level.

Each member used in the present embodiment may be used in the embodiments below.

In the embodiments below, the explanation concentrates on parts which are different from those of the first embodiment.

### Second Embodiment

In the present embodiment, the immobilization of a capture substance on a biochip substrate and the detection of a biologically active substance of the first embodiment are carried out under the following conditions.

### Immobilization of Capture Substance

In the present embodiment also, as in the case of the first embodiment, when immobilizing a capture substance on a biochip substrate, a method in which a liquid in which the capture substance is dissolved or dispersed is spotted may be used.

Furthermore, in the present embodiment, an immobilization reaction of a capture substance is carried out under neutral or alkaline conditions. For example, the liquid used for spotting and in which the capture substance is dissolved or dispersed is made neutral or alkaline. It is thereby possible to more reliably react the capture substance and an active ester group in the second unit of the macromolecular substance to thus form a covalent bond. As such conditions, for example, the pH may be equal to or greater than 7.0, and may preferably be equal to or greater than 7.6. More specifically, the pH may be 8.0. Under conditions in which the pH is too low, there is less reaction of the active ester group with the capture substance, and immobilization of the capture substance might become difficult.

Furthermore, the lower limit for the pH of the liquid containing the capture substance is appropriately selected according to the type of capture substance or the material of the macromolecular substance, but the pH may be, for example, no greater than 10.

In the present embodiment also, it is preferable after spotting to wash with pure water or a buffer solution in order to remove biologically active substance that has not been immobilized.

Furthermore, in the present embodiment, after immobilization of the capture substance, when capturing the biologically active substance, the acidic or neutral liquid, for example, a solution, containing the biologically active substance may be contacted with a macromolecular substance on the substrate. The liquid containing the biologically active substance may be neutral or acidic and, specifically, may have the pH conditions described above in the first embodiment. It is thereby possible to make the biologically active substance interact more stably with the capture substance while suppressing nonspecific adsorption thereof.

In the present embodiment, the constitution described in the first embodiment may be employed as the constitution of the biochip substrate and the biochip.

For example, the constitution of the biochip of the present embodiment may be a constitution shown in (i) to (x) below,

(i) A constitution in which, on a substrate having on its surface a macromolecular layer having a phosphorylcholine group and an active ester group, a molecule that captures a biologically active substance is immobilized on the substrate surface via the active ester group,
(ii) a constitution in which the phosphorylcholine group is included in a 2-methacryloyloxyethyl phosphorylcholine group,
(iii) a constitution in which the active ester group is a p-nitrophenyl group,
(iv) a constitution in which the macromolecular substance is a copolymer containing a butyl methacrylate group,
(v) a constitution in which the substrate is made of a plastic,
(vi) a constitution in which the plastic is a saturated cyclic polyolefin,
(vii) a constitution in which the substrate is made of a glass.
(viii) A constitution in which the capture substance is at least one of a nucleic acid, a protein, an oligopeptide, a sugar chain, and a glycoprotein,
(ix) a constitution in which, further, a biologically active substance is captured by the biochip,
(x) a constitution in which the biologically active substance is at least one of a nucleic acid, a protein, an oligopeptide, a sugar chain, and a glycoprotein.

According to the present embodiment, by suppressing nonspecific adsorption or bonding of a detection target substance without coating with an adsorption inhibitor, there is obtained a biochip having high detection accuracy and detection sensitivity when used for detection and analysis of a protein, a nucleic acid, et cetera.

### Third Embodiment

In the present embodiment, immobilization of a capture substance is carried out using the biochip substrate described in the first embodiment under the conditions described in the second embodiment. The conditions for immobilization of the capture substance may be the conditions described in the second embodiment.

Furthermore, in the present embodiment, after immobilization of the capture substance, a liquid containing a biologically active substance that is a detection target is contacted with the macromolecular substance on the substrate to thus allow the capture substance to capture the biologically active substance. During this process, the pH of the liquid containing the biologically active substance is equal to or less than the pH of the liquid containing the capture substance, and preferably lower than the pH of the liquid containing the capture substance.

It is thereby possible to more reliably suppress reaction of the biologically active substance with the active ester group.

Specifically, immobilization of the capture substance on the biochip substrate and detection of the biologically active substance may be carried out by procedures (1) and (2) below.

(1) Immobilizing the capture substance at a pH of equal to or greater than 7.6, and
(2) contacting the substrate surface with a solution containing a biologically active substance that is to be detected and having a pH of equal to or less than 7.6, thus allowing the capture substance to capture the biologically active substance.

According to the present embodiment, there can be obtained a biochip having high detection accuracy and detection sensitivity by controlling the pH of the liquid containing the biologically active substance and suppressing nonspecific adsorption or bonding of a detection target substance without coating with an adsorption inhibitor. Furthermore, by the use of a microarray substrate as a microchip substrate, a microarray having excellent detection sensitivity is obtained.

In the present embodiment, the constitution described in the first embodiment or other embodiments may be used as the constitution of the biochip substrate and the biochip.

### Fourth Embodiment

The biochip substrate of the present embodiment has on the surface of the substrate a first layer that includes a compound having an amino group and a second layer that contains a macromolecular substance having a first unit containing a phosphorylcholine group and a second unit containing a carboxylic acid derivative. The substrate, the first layer, and the second layer are layered in that order.

As the substrate, for example, the material and the shape described in the first embodiment may be used. For example, the substrate may be made of a plastic such as a saturated cyclic polyolefin or a glass.

The first layer includes a compound having an amino group. The first layer functions as an adhesive layer for immobilizing the second layer on the substrate and suppressing peel off thereof. The first layer may include an aminosilane such as, for example, a silane coupling agent having an amino group. It is thereby possible to provide the first layer on the substrate surface more stably and more reliably cover the substrate surface with the first layer. The silane coupling agent having an amino group may be present in the form of an organosiloxane, a polyorganosiloxane, et cetera.

The thickness of the first layer may be, for example, equal to or greater than 1 Å (0.1 nm). It is thereby possible to reliably cover the substrate surface and more reliably suppress peel off of the second layer from the substrate surface. Furthermore, the upper limit for the thickness of the first layer is not particularly limited, but it may be, for example, equal to or smaller than 100 Å (10 nm).

The second layer has the function of covering the top of the substrate and providing a surface state that is suitable for detection, et cetera, of a biologically active substance. The macromolecular substance constituting the second layer is a polymer having both the property of suppressing nonspecific adsorption of a biologically active substance and the property of immobilizing the biologically active substance. The phosphorylcholine group in the macromolecular substance plays a role in suppressing nonspecific adsorption of a biologically active substance. Furthermore, the carboxylic acid derivative group in the macromolecular substance plays a role in reacting with the amino group of the compound in the first layer and a role in immobilizing the capture substance.

As the macromolecular substance, for example, the constitution described in the first embodiment may be employed. Moreover, the carboxylic acid derivative group and the group that contains the phosphorylcholine group in the macromolecular substance may be, for example, the groups cited as examples in the first embodiment. For example, the constitution may be such that the first unit of the macromolecular substance has a 2-methacryloyloxyethyl phosphorylcholine group. Moreover, the constitution may be such that the second unit of the macromolecular substance has a p-nitrophenyl group. Furthermore, in the present embodiment also, as in the first embodiment, the macromolecular substance may have a third unit containing a butyl methacrylate group. A case in which the activated carboxylic acid derivative is an active ester group is explained below as an example.

The thickness of the second layer may be, for example, equal to or greater than 5 nm. It is thereby possible to reliably cover the substrate surface provided with the first layer and more reliably suppress nonspecific adsorption of a biologically active substance, et cetera. Furthermore, the upper limit for the thickness of the second layer is not particularly limited, but it may be, for example, equal to or smaller than 100 nm.

An intervening layer may or may not be present between the substrate and the first layer and between the first layer and the second layer. According to a constitution in which the first layer is provided so as to be in contact with the substrate and the second layer is provided so as to be in contact with the first layer, and a layered mode in which substantially no intervening layer is present, it is possible to yet more reliably suppress peel off of the macromolecular substance from the substrate during production or use of the biochip.

Furthermore, the constitution may be such that the amino group of the first layer and some of the active ester groups in the second layer react to thus form a covalent bond, specifically, an amide bond. It is thereby possible to yet more reliably immobilize the second layer on the substrate and suppress peel off of the second layer. Moreover, it is possible to chemically immobilize a capture substance for capturing a biologically active substance on the biochip substrate using the remainder of the active ester groups, thus giving a biochip.

A process for producing a biochip substrate related to the present embodiment is now explained. The process for producing a biochip substrate of the present embodiment may include providing a first layer on a substrate, and providing a second layer on the first layer. In the case of a constitution in which the first layer is provided so as to be in contact with the substrate and the second layer is provided so as to be in contact with the first layer, the production of the biochip substrate may include (1) and (2) below.

(1) Contacting the surface of the substrate with a compound having an amino group, and
(2) contacting the compound having an amino group with a macromolecular substance.

The above-mentioned (1) is first explained. As a result of (1), the first layer is formed on the substrate.

In order to incorporate the first layer, which contains the compound having an amino group, into the substrate surface, a method such as an aminoalkylsilane treatment, a plasma treatment under a nitrogen atmosphere, or coating with an amino group-containing macromolecular substance may be used. Among these, the aminoalkylsilane treatment is preferably used from the viewpoint of simplicity and uniformity.

The aminoalkylsilane treatment may be carried out by, for example, immersing a substrate in an aminoalkylsilane (coupling agent) solution and thermally treating it. The concentration of the aminoalkylsilane solution is, for example, 0.1 wt % or more and 10 wt % or less, preferably 0.1 wt % or more and 5 wt % or less, and more preferably 1 wt % or more and 5 wt % or less. By making the aminoalkylsilane concentration at least 0.1 wt %, and preferably at least 1 wt %, it is possible to yet more reliably form the compound having an amino group in the form of a layer on the surface of the substrate. Furthermore, by making the aminoalkylsilane concentration not greater than 10 wt %, preferably not greater than 5 wt %, and more preferably not greater than 1 wt %, it is possible to dispose the aminoalkylsilane compound uniformly on the substrate. Because of this, variation in the film thickness of the first layer can be suppressed.

The above-mentioned (2) is now explained. As a result of (2), the second layer is formed on the first layer.

When forming, on top of the first layer, a second layer containing a macromolecular substance having a first unit containing a phosphorylcholine group and a second unit containing an active ester group, for example, a method in which a substrate is immersed in a solution of the macromolecular substance having a phosphorylcholine group and an active ester group may be used. The concentration of the macromolecular substance having a phosphorylcholine group and an active ester group is, for example, 0.05 wt % or more and 5.0 wt % or less, and preferably 0.1 wt % or more and 1.0 wt % or less.

By making the concentration of the macromolecular substance at least 0.05 wt %, and preferably at least 0.1 wt %, it is possible to reliably provide the second layer, which covers the first layer. Furthermore, by making the concentration of the macromolecular substance not greater than 5.0 wt %, and preferably not greater than 1.0 wt %, it is possible to form the second layer uniformly on the first layer and suppress variation in the film thickness of the second layer.

According to the present embodiment, there is obtained a biochip substrate that has high detection accuracy or detection sensitivity and that suppresses nonspecific adsorption or bonding of a detection target substance without coating with an adsorption inhibitor, and for which there is no film peel off even by washing with a surfactant.

By the use of the biochip substrate of the present embodiment, it is possible to immobilize various types of capture substances and give a biochip. Furthermore, by the use of the biochip, it is possible to carry out detection, et cetera, of a biologically active substance.

In the present embodiment also, the substances described in the first embodiment may, for example, be used as the capture substance and the biologically active substance. Furthermore, in the present embodiment, the constitution described in the first embodiment or the above-mentioned other embodiments may be used as the constitution of the biochip substrate and the biochip.

### Fifth Embodiment

The present embodiment relates to a biochip employing the biochip substrate described in the above-mentioned embodiments. The biochip of the present embodiment has a constitution in which, with regard to a biochip substrate having on the surface of the substrate a macromolecular substance having a phosphorylcholine group and a plurality of carboxylic acid derivative groups, some of the carboxylic acid derivative groups and a capture substance for capturing a biologically active substance react to form a covalent bond, and the remainder of the carboxylic acid derivative groups and a hydrophilic polymer having a hydrophilic group react to form a covalent bond. By incorporation of the hydrophilic polymer into the macromolecular substance via the covalent bond, it is possible to further reduce nonspecific adsorption of a protein onto the macromolecular substance on the surface of the biochip.

As the biochip substrate, the constitution of any one of the biochip substrates described in other embodiments of the present specification may be used. A case in which the biochip substrate described in the first embodiment is used is explained below as an example. The macromolecular substance of the biochip substrate may have a constitution such that, for example, the first unit contains a 2-methacryloyloxyethyl phosphorylcholine group, and the second unit has a p-nitrophenyl group as the active ester group, which is one embodiment of the activated carboxylic acid derivative group. Furthermore, the macromolecular substance represented by formula (2) above may be used.

Moreover, the biochip of the present embodiment may include immobilizing a capture substance by reacting some active ester groups among a plurality of active ester groups contained in the macromolecular substance of the biochip substrate with the capture substance so as to form a covalent bond with the capture substance and, after immobilization of the capture substance, reacting the remainder of the active ester groups with a hydrophilic polymer so as to form a covalent bond with the hydrophilic polymer.

### Immobilization of Capture Substance

The immobilization of a capture substance on the biochip substrate may be carried out by the method described in the above-mentioned embodiments, for example, the method described in the second embodiment. Specifically, in the present embodiment also, as in the above-mentioned embodiments, when immobilizing a capture substance on the biochip substrate, a method in which a liquid in which a biologically active substance is dissolved or dispersed is spotted may be used. The pH of the liquid in which the capture substance is dissolved or dispersed may be neutral or alkaline, and may preferably be equal to or greater than 7.6. Furthermore, after the spotting, in order to remove capture substance that has not been immobilized, washing may be carried out with pure water or a buffer solution.

In the present embodiment, after immobilization of the capture substance and after washing, an area of the substrate surface other than the area on which the capture substance has been spotted, that is, the active ester group remaining on the substrate, is converted into a hydrophilic polymer. Incorporation of the hydrophilic polymer into the macromolecular substance is explained below.

### Incorporation of Polymer having Hydrophilic Group

In the present invention, the active ester groups of the substrate surface other than those with which the biologically active substance has been immobilized are further reacted with a hydrophilic polymer, thus modifying the macromolecular substance with the hydrophilic polymer.

The hydrophilic polymer is a polymer having a hydrophilic group, and may contain in the structure, for example, a polyalkylene oxide or a plurality of types of polyalkylene oxide. It may contain in the structure as the polyalkylene oxide, for example, polyethylene glycol, polypropylene glycol, a copolymer thereof, or a copolymer of at least one thereof and another polyalkylene oxide.

Furthermore, the hydrophilic polymer preferably has an aminated terminal in order to enhance the reactivity with an active ester group. Specific examples of hydrophilic polymers at the terminal of which an amino group is incorporated include the Jeffamine M series (XTJ-505, XTJ-6506, XTJ-507, M-2070, XTJ-234) manufactured by Sun Technochemical Inc.

In order to incorporate a hydrophilic polymer into an active ester group, it is preferable to employ a method in which a substrate having a biologically active substance immobilized thereon is immersed in a liquid such as a solution of a hydrophilic polymer. The concentration of the hydrophilic polymer in the liquid containing the hydrophilic polymer may be, for example, equal to or greater than 0.1 wt %. By so doing, the hydrophilic polymer may reliably be incorporated into the macromolecular substance. Furthermore, the concentration of the hydrophilic polymer may be, for example, equal to or less than 100 wt %. When a polymer that gives a high solution viscosity is used, it is preferable to use it diluted. It is thereby possible to stably incorporate the hydrophilic polymer into the macromolecular substance.

Since the biochip related to the present embodiment has a constitution in which, due to the incorporation of the hydrophilic polymer, the remaining active ester groups have been eliminated, it is possible to suppress nonspecific adsorption or bonding of a detection target substance without coating with an adsorption inhibitor, thus yet more reliably improving the detection sensitivity.

In the present embodiment, the constitution described in the first embodiment or the above-mentioned other embodiments may be used as the constitution of the biochip substrate and the biochip.

### Sixth Embodiment

In the biochip substrate described in the first embodiment and the biochip substrate described in the above-mentioned other embodiments, when the carboxylic acid derivative group contained in the second unit of the macromolecular substance is an active ester group, the active ester group may be an N-hydroxysuccinimide group.

For example, with regard to the biochip having immobilized on the biochip substrate a capture substance having biological activity, such as a primary antibody, in an immobilization method for the capture substance, an immobilization method involving physical adsorption, an immobilization method involving a chemical reaction, et cetera, is used.

In the chemical immobilization method, there is a known method in which immobilization is effected by reacting with an amino group of the biologically active substance using an active ester. However, the reactivity of an active ester group with an amino group varies greatly, depending on the type of ester.

For example, p-nitrophenyl esters have excellent reactivity at a relatively high pH. Because of this, depending on the type of capture substance having biological activity, there is a possibility that sufficient signal strength might not be obtained due to denaturing, decomposition, et cetera, of the capture substance caused by the high pH.

In such a case, by employing an N-hydroxysuccinimide group as the active ester group, the capture substance can be immobilized at a lower pH, for example, a pH of 7.4 or more and 9.0 or less. Because of this, even in the case of a capture substance that has low stability at a high pH, it is possible to immobilize it on a macromolecular substance in a stable manner while maintaining biological activity.

The basic constitution of the biochip substrate of the present embodiment may be the same as the biochip substrate described in the first embodiment, except that the second unit of the macromolecular substance has an N-hydroxysuccinimide group.

For example, with regard to the biochip substrate having the macromolecular substance on the surface of the substrate, as a combination of the first unit and the second unit in a further specific constitution, the constitution may be such that, for example, the first unit containing a phosphorylcholine group has a 2-methacryloyloxyethyl phosphorylcholine group and the active ester group is an N-hydroxysuccinimide group.

According to the present embodiment, since nonspecific adsorption or bonding of a detection target substance can be suppressed without coating the substrate with an adsorption inhibitor, it is possible to improve the signal strength.

In the present embodiment, the constitution described in the first embodiment or the above-mentioned other embodiments may be used as the constitution of the biochip substrate and the biochip.

### Seventh Embodiment

In the biochip substrate described in the above-mentioned embodiments, the proportion of the phosphorylcholine group in the first unit of the macromolecular substance, and the proportion of the activated carboxylic acid derivative group contained in the second unit of the macromolecular substance may also be as follows. A case in which the activated carboxylic acid derivative group is an active ester group is explained below.

In the present embodiment, as the constituents of the biochip substrate and the biochip, those described in the first embodiment or the above-mentioned other embodiments may be used.

In the present embodiment, the macromolecular substance on the substrate may have a constitution that is formed from component (a) below.

(a) a macromolecule in which a first unit containing a phosphorylcholine group and a second unit having an active ester group are essential components and a third unit having a butyl methacrylate group is an optional component

In this case, the proportion of the phosphorylcholine group contained in the macromolecular substance relative to the total of the phosphorylcholine group, the active ester group, and the butyl methacrylate group may be, for example, equal to or greater than 3 mol %, and preferably equal to or greater than 25%. If the proportion of the phosphorylcholine group is too small, there is a possibility that, when used as a chip, nonspecific adsorption of a biologically active substance might occur and the background might increase.

Furthermore, the proportion of the phosphorylcholine group contained in the macromolecular substance on the substrate relative to the total of the phosphorylcholine group, the active ester group, and the butyl methacrylate group may be, for example, equal to or less than 40 mol %, preferably less than 40 mol %, more preferably equal to or less than 35 mol %, and yet more preferably less than 35 mol %. If the proportion of the phosphorylcholine group is too large, since the water solubility of a mixed polymer becomes high, there is a possibility that a surface layer might peel off.

Furthermore, the proportion of the active ester group contained in the macromolecular substance relative to the total of the phosphorylcholine group and the active ester group is, for example, at least 1 mol % or more and 25 mol % or less. If the proportion of the active ester group is too small, there is a possibility that the amount of biologically active substance immobilized might decrease and that a sufficient signal might not be obtained. Moreover, if the proportion of the active ester group is too large, there is a possibility that the amount of active ester group present on the uppermost surface might reach saturation and the signal strength might not improve.

More specifically, the proportion of the active ester group contained in the macromolecular substance relative to the total of the phosphorylcholine group and the active ester group may be, for example, at least 15 mol % but less than 25 mol %. Furthermore, from the viewpoint of yet more reliably decreasing the background in a detection reaction for a biologically active substance, the proportion of the active ester group contained in the macromolecular substance relative to the total of the phosphorylcholine group and the active ester group is preferably 1 mol % or more and 8% or less. By making it 1 mol % or more and 8% or less, it is possible to further improve the detection sensitivity.

Furthermore, the macromolecular substance may have the following constitution, which is formed from component (a) above and component (b) below.

(b) a macromolecule having a first unit containing a phosphorylcholine group and a third unit containing a butyl methacrylate group

The first unit of the above-mentioned (a) and the first unit of the above-mentioned (b) may have the same structure or different structures. Furthermore, when the above-mentioned (a) contains the third unit containing a butyl methacrylate group, the third unit of (a) and the third unit of the above-mentioned (b) may have the same structure or different structures.

The component (b) is used as a polymer that suppresses nonspecific adsorption of a biologically active substance. As such a polymer, for example, MPC polymer (manufactured by NOF Corporation), which contains 30 mol % phosphorylcholine groups and 70 mol % butyl methacrylate groups may be used.

When the macromolecular substance is formed from the above-mentioned components (a) and (b), the constitution may be such that the components (a) and (b) are mixed. Since the polymers of the above-mentioned component (a) and component (b) can be dissolved in, for example, an ethanol solution, by mixing respective polymer solutions it is possible to easily obtain a mixed polymer.

The proportion of the phosphorylcholine group contained in the mixed polymer formed from the above-mentioned components (a) and (b) relative to the total of the phosphorylcholine group, the active ester group, and the butyl methacrylate group is, for example, equal to or greater than 3 mol %, and preferably equal to or greater than 25 mol %. In the mixed polymer also, if the proportion of the phosphorylcholine group is too small, there is a possibility that nonspecific adsorption of a biologically active substance might occur and the background might increase.

Furthermore, the proportion of the phosphorylcholine group contained in the mixed polymer formed from the above-mentioned components (a) and (b) relative to the total of the phosphorylcholine group, the active ester group, and the butyl methacrylate group is, for example, equal to or less than 40 mol %, preferably less than 40 mol %, more preferably equal to or less than 35 mol %, and yet more preferably less than 35 mol %. In the mixed polymer also, if the proportion of the phosphorylcholine group is too large, since the water solubility of the mixed polymer becomes high, there is a possibility that a surface layer might peel off.

Furthermore, the proportion of the active ester group contained in the mixed polymer formed from the above-mentioned components (a) and (b) relative to the total of the phosphorylcholine group, the active ester group, and the butyl methacrylate group may be, for example, 1 mol % or more and 25 mol % or less. In the case of the mixed polymer also, if the proportion of the active ester group is too small, there is a possibility that the amount of biologically active substance immobilized might decrease and a sufficient signal might not be obtained. Moreover, if the proportion of the active ester group is too large, the amount of active ester group present on the uppermost surface might reach saturation, and the signal strength might not improve.

More specifically, the proportion of the active ester group contained in the mixed polymer formed from components (a) and (b) relative to the total of the phosphorylcholine group and the active ester group may be, for example, equal to or more than 15 mol % and less than 25 mol %. Furthermore, from the viewpoint of yet more reliably decreasing the background in a detection reaction of a biologically active substance, the proportion of the active ester group contained in the mixed polymer formed from components (a) and (b) relative to the total of the phosphorylcholine group and the active ester group is more preferably 1 mol % or more and 8% or less. By making it 1 mol % or more and 8% or less, the detection sensitivity can be further improved.

In the present embodiment also, for example, a p-nitrophenyl group, an N-hydroxysuccinimide group, et cetera, may be used as the active ester group.

In accordance with the use of a capture substance in the biochip substrate of the present embodiment, a biochip having excellent detection sensitivity can be obtained. For production of a biochip using the biochip substrate, the method described in the above-mentioned embodiments may be used.

For example, in the present embodiment also, when immobilizing a capture substance on the biochip substrate, a method in which a liquid in which a biologically active substance is dissolved or dispersed is spotted may be used. Furthermore, the pH of the liquid in which the capture substance is dissolved or dispersed may be equal to or greater than 7.6. Moreover, after spotting, in order to remove material that has not been immobilized, washing may be carried out with pure water or a buffer solution. Furthermore, after washing, an area other than the area on which the biologically active substance is spotted may be modified with a hydrophilic polymer.

According to the present embodiment, it is possible to obtain a biochip having high detection accuracy or detection sensitivity by suppressing nonspecific adsorption or bonding of a detection target substance without coating with an adsorption inhibitor.

### Eighth Embodiment

The present embodiment relates to a microarray substrate having the biochip substrate described in the above-mentioned embodiments. This microarray substrate has on a substrate surface a macromolecular substance having a first unit containing a phosphorylcholine group and a second unit containing an active ester group.

In the present embodiment, with regard to constituents, materials, and a production process for the microarray substrate, those described in the above-mentioned embodiments may be used.

The microarray substrate of the present embodiment has a constitution in which autofluorescence is reduced and adsorption of a fluorescent dye is reduced. Because of this, an information signal from a sample can be detected as fluorescence with higher sensitivity. This microarray substrate is suitably used as a microarray substrate for immobilizing a capture substance for capturing a biologically active substance on the surface of the substrate, and detecting the biologically active substance using a fluorescent dye.

Furthermore, by the use of the microarray substrate of the present embodiment, for example, a microarray suitably used as a microarray for detecting a biologically active substance using a fluorescent dye can be obtained. For example, a microarray may be obtained by immobilizing on the microarray substrate at least one capture substance selected from a nucleic acid, an aptamer, a protein, an enzyme, an antibody, an oligopeptide, a sugar chain, and a glycoprotein. In the present specification, the microarray is not limited to a DNA microarray, but means a device in which a predetermined capture substance having biological activity is integrated on a substrate (made into a chip).

In the present embodiment, as the constitution of the microarray substrate and the microarray, the constitution of the microchip substrate and the microchip described in the first embodiment or the above-mentioned other embodiments may be used.

For example, the constitution of the biochip of the present embodiment may be a constitution shown in (i) to (vi) below.

(i) a microarray substrate in which the phosphorylcholine group is a 2-methacryloyloxyethyl phosphorylcholine group,
(ii) a microarray substrate in which the active ester group is a p-nitrophenyl group or an N-hydroxysuccinimide group,
(iii) a microarray substrate in which the macromolecular substance is a copolymer containing a butyl methacrylate group.
(iv) a microarray substrate in which the substrate is made of a plastic,
(v) a microarray substrate in which the plastic is a saturated cyclic polyolefin,
(vi) a microarray substrate in which the substrate is made of a glass.

### Ninth Embodiment

The present embodiment relates to another constitution of the microchip substrate having provided on a substrate a macromolecular substance having a first unit containing a phosphorylcholine group and a second unit containing a carboxylic acid derivative group. The microchip substrate of the present embodiment has a substrate, a first layer provided on the substrate and containing an organosiloxane, and a second layer provided on the first layer and containing a copolymer of a monomer having a phosphorylcholine group and a monomer having a carboxylic acid derivative group. Layers are provided in which the substrate, the first layer, and the second layer are layered in that order. A case in which the carboxylic acid derivative group is an active ester group is explained below as an example.

In this constitution, the organosiloxane constituting the first layer may be a compound having a group having a polymerizable double bond. The group having a polymerizable double bond may constitute an alkenyl group (olefin group). Furthermore, at least some of the groups having a polymerizable double bond may constitute an acrylate group, a methacrylate group, or a vinyl group. The first layer may have a compound having at least one group selected from an acrylate group, a methacrylate group, a vinyl group, and another alkenyl group.

With regard to the constitution of the substrate, the substrate described in the above-mentioned embodiments may be used.

The first layer is a layer that, when forming the layered second layer by a polymerization such as radical polymerization, photopolymerization, or radical ion polymerization of a monomer, reacts with a monomer in the second layer and immobilizes the second layer on the substrate by a covalent bond.

The thickness of the first layer is, for example, equal to or greater than 1 Å (0.1 nm). It is thereby possible to reliably cover the substrate surface and more reliably suppress peel off of the second layer from the substrate surface. Furthermore, the upper limit for the thickness of the first layer is not particularly limited, but it may be, for example, no greater than 100 Å (10 nm).

The second layer has the function of covering the top of the substrate and providing a surface state suitable for detection, et cetera, of a biologically active substance. The second layer has both the property of suppressing nonspecific adsorption of a biologically active substance and the property of immobilizing a capture substance. The phosphorylcholine group of the copolymer in the second layer plays a role in suppressing nonspecific adsorption of a biologically active substance, and the active ester group of the copolymer plays a role in immobilizing a biologically active substance.

The thickness of the second layer may be, for example, equal to or greater than 5 nm. It is thereby possible to reliably cover the substrate surface having the first layer provided thereon, and more reliably suppress nonspecific adsorption of the biologically active substance, et cetera. Furthermore, the upper limit for the thickness of the second layer is not particularly limited, but it may be, for example, equal to or smaller than 100 nm.

An intervening layer may or may not be present between the substrate and the first layer or between the first layer and the second layer. According to a constitution in which the first layer is provided so as to be in contact with the substrate and the second layer is provided so as to be in contact with the first layer, and a layered mode in which substantially no intervening layer is present, it is possible to yet more reliably suppress peel off of the macromolecular substance from the substrate during production or use of the biochip. Furthermore, the constitution may be such that the organosiloxane in the first layer has a group having a polymerizable double bond, and the group having a polymerizable double bond and the copolymer react to form a covalent bond.

Moreover, in the present embodiment, the first layer may be formed only from a compound having at least one group selected from an acrylate group, a methacrylate group, a vinyl group, or another alkenyl group, and the second layer may be formed only from a copolymer. Furthermore, the constitution may be such that the first layer is provided on the surface of the substrate, and the second layer is provided on the surface of the first layer.

A process for producing the biochip substrate of the present embodiment is now explained. This biochip substrate is obtained by forming the first layer on the substrate surface and then forming the second layer by copolymerizing on the first layer a monomer having a phosphorylcholine group and a monomer having an active ester group.

As the organosiloxane used for formation of the first layer on the substrate surface, a silane coupling agent having a polymerizable double bond may be used. The silane coupling agent may be present in the form of an organosiloxane on the substrate. Furthermore, the organosiloxane is preferably a silane coupling agent having at least one group selected from an acrylate group, a methacrylate group, a vinyl group, and another olefin group.

Examples of these silane coupling agents include (3-acryloxypropyl)trimethoxysilane, methacryloxypropyltrimethoxysilane, N-(3-acryloxy-2-hydroxypropyl)-3-aminopropyltriethoxysilane, N-(3-methacryloxy-2-hydroxypropyl)-3-aminopropyltriethoxysilane, methacryloxypropyltriethoxysilane, methacryloxymethyltriethoxysilane, methacryloxymethyltrimethoxysilane, (3-acryloxypropyl)methyldimethoxysilane, methacryloxypropylmethyldiethoxysilane, methacryloxypropylmethyldimethoxysilane, methacryloxypropyldimethylethoxysilane, methacryloxypropyldimethylmethoxysilane, allyltrimethoxysilane, 3-(N-styrylmethyl-2-aminoethylamino)-propyltrimethoxysilane, vinyltriacetoxysilane, vinyltriethoxysilane, vinyltriisopropenoxysilane, vinyltriisopropoxysilane, vinyltrimethoxysilane, vinyltris(2-methoxyethoxy)silane, vinyltris(methylethylketoxyimino)silane, allyloxyundecyltrimethoxysilane, allyltriethoxysilane, norbornenyltriethoxysilane, 3-butenyltriethoxysilane, 2-(chloromethyl)allyltrimethoxysilane, (2-(3-cyclohexenyl)ethyl)triethoxysilane, (2-(3-cyclohexenyl)ethyl)trimethoxysilane, (3-cyclopentadienylpropyl)triethoxysilane, docosenyltriethoxysilane, 7-octenyltrimethoxysilane, styrylethyltrimethoxysilane, vinyltri-t-butoxysilane, vinyltris, (methoxypropoxy)silane, vinylmethyldiethoxysilane, vinylmethyldimethoxysilane, 1,3-divinyltetramethyldisilazane, vinyldimethylethoxysilane, trivinylmethoxysilane, bis(triethoxysilyl)ethylene, bis(trimethoxysilylmethyl)ethylene, triethoxysilyl-modified poly 1,2-butanediene, and the like.

Formation of the first layer with a silane coupling agent may be carried out by, for example, immersing a substrate in a solution of the silane coupling agent and thermally treating it. The concentration of the silane coupling agent solution may be equal to or greater than 0.1 wt %, and may preferably be equal to or greater than 1 wt %. It is thereby possible to more reliably form the first layer. Furthermore, the concentration of the silane coupling agent solution may be, for example, equal to or less than 10 wt %, and may preferably be 5 wt %. It is thereby possible to yet more stably form the first layer on the substrate.

In order to incorporate onto the top of the first layer the second layer, which contains a polymer of a monomer having a phosphorylcholine group and a polymer of a monomer having an active ester group, the substrate having the first layer formed thereon may, for example, be immersed in a solution of the monomer having a phosphorylcholine group and the monomer having an active ester group so as to polymerize each monomer. The polymerization may be carried out by radical polymerization, radical ion polymerization, photopolymerization, et cetera. A polymerization initiator may be added to the solution of the monomer having a phosphorylcholine group and the monomer having an active ester group.

Examples of the monomer having a phosphorylcholine group include 2-methacryloyloxyethyl phosphorylcholine, 2-methacryloyloxyethoxyethyl phosphorylcholine, 6-methacryloyloxyhexyl phosphorylcholine, 10-methacryloyloxyethoxynonyl phosphorylcholine, allyl phosphorylcholine, butenyl phosphorylcholine, hexenyl phosphorylcholine, octenyl phosphorylcholine, decenyl phosphorylcholine or the like, and 2-methacryloyloxyethyl phosphorylcholine is preferable.

With regard to the monomer having an active ester group, for example, a monomer having an active ester group described in the first embodiment as the active ester group, more specifically, a p-nitrophenyl group, an N-hydroxysuccinimide group, et cetera, is preferable, and a monomer further having a methacrylic group or an acrylic group is preferable. p-Nitrophenylcarbonyloxyethyl methacrylate is particularly preferable.

When used for detection and analysis of a protein, a nucleic acid, et cetera, the biochip substrate obtained as above suppresses nonspecific adsorption or bonding of a detection target substance without coating with an adsorption inhibitor, gives no film peel off due to a surfactant, and has excellent detection accuracy and detection sensitivity. Furthermore, a biochip capable of, for example, detecting a biologically active substance can be obtained by immobilizing various types of capture substance on the biochip substrate obtained above.

In the present embodiment, the capture substance and the biologically active substance may be, for example, the materials described in the above-mentioned embodiments. Furthermore, in the present embodiment, as the constitution of the biochip substrate and the biochip, the constitution described in the first embodiment or the above-mentioned other embodiments may be used.

### Tenth Embodiment

The present embodiment relates to a biochip employing the biochip substrate described in the above-mentioned embodiments. Furthermore, the present embodiment relates to a biochip for carrying out analysis of a protein, a nucleic acid, et cetera, in a biological sample using a micro channel.

The biochip of the present embodiment has a substrate and a channel provided on the substrate. The channel may be provided in the form of, for example, a groove on the surface of the substrate. This biochip has on the surface of the channel a macromolecular substance having a first unit containing a phosphorylcholine group and a second unit containing an active ester group. Furthermore, the active ester group and the capture substance for capturing a biologically active substance react to form a covalent bond.

Moreover, the biochip may have a protecting member covering the channel. It is thereby possible to suppress drying of contents of the channel or its leaking to the outside of the channel. Because of this, it is possible to more stably carry out analysis using the biochip. Although the shape of the protecting member is not particularly limited it may, for example, be in the form of a plate, a sheet, or a film. The biochip of the present embodiment is explained below in further detail taking a constitution having a plate-form substrate and a plate-form protecting member as an example.

FIG. 1 is a plan view showing the constitution of the biochip related to the present embodiment. The biochip shown in FIG. 1 has a substrate 103 formed by joining two plate-form members, that is, a channel substrate and a cover substrate, a groove 102 provided on the joined face of the substrate 103, and through holes 101 provided at opposite ends of the groove 102 and communicating with the groove 102. In FIG. 1, three grooves 102 are provided parallel to each other on the surface of the channel substrate forming the substrate 103.

The groove 102 functions as a micro channel through which a liquid can flow. Furthermore, the through holes 101 function as inlets for a liquid such as a test liquid into the groove 102. Furthermore, since the through holes 101 are connected to the outside air, they also function as air inlets for making the liquid in the groove 102 flow.

The substrate 103 has a macromolecular substance having a first unit containing a phosphorylcholine group and a second unit containing a carboxylic acid derivative group on the surface of the groove 102, that is, on part or all of the surface of the micro channel. A capture substance for capturing a biologically active substance is immobilized on the macromolecular substance on the substrate 103. The carboxylic acid derivative group and the capture substance react to form a covalent bond. A capture substance having biological activity, such as, for example, DNA or a protein is thereby immobilized on the substrate.

The macromolecular substance has a plurality of carboxylic acid derivative groups, and the plurality of carboxylic acid derivative groups react with the capture substance to thus form a covalent bond, or are deactivated. The carboxylic acid derivative group being deactivated referred to here means that a group (leaving group) constituting part of the carboxylic acid derivative group is substituted by another group and the activity is lost.

The macromolecular substance may be a material described in the above-mentioned embodiments. The carboxylic acid derivative group contained in the second unit of the macromolecular substance may be, for example, a group described in the first embodiment. For example, the carboxylic acid derivative group may be an active ester group. A case in which the carboxylic acid derivative group is an active ester group is explained below as an example. Furthermore, the active ester group may be selected depending on the capture substance that is a target for immobilization, and is, for example, the group described in the first embodiment, and more specifically a p-nitrophenyl group or an N-hydroxysuccinimide group.

The macromolecular substance may be formed on the surface of the groove 102 in the form of a layer. It is thereby possible to more reliably suppress nonspecific adsorption onto the surface of the groove 102. The thickness of the layer formed from the macromolecular substance is not particularly limited, but it may be, for example, equal to or greater than 5 nm. Furthermore, a film-form macromolecular substance may be provided on the surface of the groove 102. It is thereby possible to more stably cover the surface of the groove 102 with a film of the macromolecular substance. Furthermore, the macromolecular substance may be provided on all of the surface of the groove 102. It is thereby possible to yet more reliably suppress nonspecific adsorption onto the surface of the groove 102.

The material for the substrate 103 may be, for example, the material for the substrate used in the above-mentioned embodiments. Specifically, a glass, a plastic, a metal, and others may be used, but from the viewpoint of ease of surface treatment and mass productivity, a plastic is preferable, and a thermoplastic resin is more preferable.

Furthermore, among the channel substrate and the cover substrate constituting the substrate 103, at least one thereof may be a resin that is transparent to detection light. The material for the transparent resin is appropriately selected according to the wavelength of detection light used for a detection reaction of a biologically active substance but, for example, a saturated cyclic polyolefin, PMMA, polystyrene, polycarbonate, et cetera, can be cited. By making at least one of the channel substrate and the cover substrate transparent, it becomes possible to easily check a liquid feed state. Furthermore, it is also possible to appropriately color at least one of the channel substrate and the cover substrate. By so doing, when a reaction within the channel is observed optically, an effect in increasing the sensitivity can be expected.

The constitution may be such that the biochip shown in FIG. 1 is used for detection or quantification of a biologically active substance in a test liquid, the biologically active substance having been captured on the capture substance by making the test liquid flow through the channel. Furthermore, it is also possible to identify a component contained in the test liquid.

The diameter of the through holes 101 is appropriately designed according to the thickness of the cover substrate, the width of the channel, et cetera. Furthermore, the groove 102, which becomes the channel, may have the constitution below. In order to efficiently carry out a detection reaction of a biologically active substance in the channel of the biochip having a capture substance immobilized on the biochip substrate, a certain degree of flow rate is necessary. Furthermore, an area that contributes to the reaction is an area of the surface of the channel on which the capture substance is immobilized. From the above, it is preferable for the cross-sectional area of the channel to be small in order to efficiently carry out a reaction with a small amount of sample liquid.

The width and depth of a cross section of the channel that is perpendicular to the direction in which the channel extends may be, for example, equal to or greater than 20 μm, and may preferably be equal to or greater than 50 μm. It is thereby possible to ensure that there is sufficient flow of the sample liquid through the channel. Furthermore, the constitution allows flow of the sample liquid to be easily controlled. Furthermore, the width and depth of the channel may be, for example, equal to or less than 500 μm, and may preferably be equal to or less than 200 μm. It is thereby possible to ensure that there is sufficient ease of recognition when carrying out fluorescence scanning in a biologically active substance capture situation such as hybridization. Furthermore, the length of the channel may be designed appropriately according to the type of detection substance, the amount of test liquid, et cetera.

A process for producing the biochip shown in FIG. 1 is now explained.

A channel substrate in which a micro channel is engraved and a cover substrate, which becomes a cover, are first prepared. The channel substrate and the cover substrate correspond to the above-mentioned substrate and protecting member respectively. The channel substrate is provided with the above-mentioned groove 102 and the through holes 101 communicating with the groove 102 and penetrating the channel substrate.

Faces of the two substrates that are joined, that is, faces on the side on which the channel is formed, are then coated with a macromolecular substance having a phosphorylcholine group and an active ester group. Coating with the macromolecular substance may be carried out by, for example, the method of the above-mentioned embodiments used for preparing a microchip substrate by attaching the macromolecular substance to the substrate.

Subsequently, a liquid in which a capture substance is dissolved or dispersed is spotted onto a predetermined position within the channel of the channel substrate, or within an area of the cover substrate where the channel is formed, or in the vicinity thereof, and allowed to stand for a predetermined period of time, thus immobilizing the capture substance. With regard to a method for spotting the liquid containing a capture substance onto the macromolecular substance, for example, spotting using a pin spotter or spotting of an inkjet system can be cited. Furthermore, the pH of the liquid containing the capture substance may be, for example, 2 or more and 11 or less. When the pH of the liquid containing the capture substance is too large or too small, there is a possibility that a biologically active substance might be denatured due to it being on the strong acid side or strong alkaline side. When the capture substance is, for example, a protein, the pH of the liquid containing the capture substance may be approximately neutral.

After immobilizing the capture substance, washing is carried out so as to remove excess capture substance that has not been immobilized. After washing, the active ester group is deactivated. The deactivation treatment may be carried out under conditions described in, for example, the first embodiment. Specifically, deactivation may be carried out using an alkaline compound or a compound having a primary amino group.

After deactivation, the channel substrate and the cover substrate are bonded together to thus form a channel through which a liquid can flow. Bonding of the two substrates may be carried out by adhesion involving coating with an adhesive or hot melt bonding. Furthermore, since the capture substance, which has biological activity, is generally sensitive to heat, when a capture substance sensitive to heat is immobilized, a thermoplastic resin may be used as the material for the substrate. By the use of a thermoplastic resin, it is possible to carry out hot melt bonding at relatively low temperature.

In the present embodiment, since the capture substance is immobilized on a macromolecular substance having a phosphorylcholine group and an active ester group, the heat resistance of the biologically active substance can be improved after immobilization. Because of this, if a thermoplastic resin is used, even if hot melt bonding is carried out the activity of the immobilized capture substance can be maintained.

As the capture substance and the biologically active substance, the materials described in the above-mentioned embodiments can be cited. Furthermore, in the present embodiment also, depending on the structure of the capture substance, an amino group may be incorporated into the capture substance. Furthermore, in the present embodiment, as the constitution of the biochip substrate and the biochip, the constitution described in the first embodiment or the above-mentioned other embodiments may be used.

A method for using the biochip of the present embodiment is now explained using as an example a case in which a primary antibody is immobilized as the capture substance on a chip.

When the biochip is used, a given amount of sample liquid is first fed using a liquid feed unit such as a micropump or a microsyringe. In this process, a detection target protein is captured by the antibody. After feeding the sample liquid, a fixed amount of washing liquid is fed so as to carry out washing.

Subsequently, a fixed amount of a secondary antibody obtained by subjecting an antibody for an analysis target protein to labeling with a fluorescent substance, et cetera, is fed, and washing is carried out. If the analysis target protein is present in the sample liquid, it can be identified as a fluorescent spot by a fluorescence scanner.

As described above, the efficiency of an antigen-antibody reaction is high, and a sufficient amount of protein can be captured by feeding a small amount of liquid. Furthermore, protein adsorption does not occur even if blocking is not carried out, washing can be carried out by feeding a small amount of washing liquid, and the background during detection can be decreased sufficiently.

According to the present embodiment, it is possible to suppress nonspecific adsorption of a component in a test liquid, that is, in this case a component containing a biologically active substance as a detection target, onto a channel without coating with an adsorption inhibitor. Because of this, the detection sensitivity can be increased. Furthermore, by forming a detection section in the form of a channel, it is possible to improve the efficiency of a specific interaction between a capture substance and a biologically active substance.

The present invention is explained above by reference to embodiments. These embodiments are for illustration only, and a person skilled in the art will understand that various modified examples are possible and such modified examples are also included in the scope of the present invention.

### EXPERIMENTAL EXAMPLES

### Experimental Example A1, Experimental Example A2

In Experimental Example A1 and Experimental Example A2, the biochip substrate and the biochip described in the first embodiment were prepared, and detection of an antibody was carried out.

### Experimental Example A1

A substrate was prepared by processing a saturated cyclic polyolefin resin (hydrogenated ring-opening polymer of 5-methyl-2 norbornene (MFR (Melt flow index): 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a macromolecular substance having a phosphorylcholine group and an active ester group was incorporated into the substrate surface.

Subsequently, a sandwich method was carried out on the substrate. In detail, antimouse IgG2a, which is a primary antibody, prepared at a dilution ratio shown in Table 1 was first spotted on the substrate using an automated spotter and then left to stand in an environment of a room temperature of 4° C. for 24 hours. Following this, by immersing it in a 0.1 N aqueous solution of sodium hydroxide, active ester was deactivated.

Subsequently, an antigen-antibody reaction was carried out with mouse IgG2a, which is an antigen, and an antigen-antibody reaction was then carried out with biotinylated antimouse IgG2a, which is a secondary antibody. Finally, a reaction with Cy5-labeled streptavidin was carried out, and a fluorescence intensity measurement was carried out for each spot. The results are given in Table 1.

### Experimental Example A2

After subjecting the surface of a substrate similar to that of Experimental Example A1 to hydrophilization, it was immersed in a 2 wt % aqueous solution of an amino group-containing alkyl silane and then subjected to a thermal treatment so as to incorporate an amino group into the surface. By immersing this in a 1 wt % aqueous solution of glutaraldehyde, the surface amino group and glutaraldehyde were reacted to thus incorporate an aldehyde group.

Subsequently, a sandwich method was carried out on the substrate. In detail, antimouse IgG2a, which is a primary antibody, prepared at a dilution ratio shown in Table 1 was first spotted on the substrate using an automated spotter and then left to stand in an environment of a room temperature of 4° C. for 24 hours. Following this, in order to prevent nonspecific adsorption, the substrate was immersed in a 9.6 g/L buffer solution of PBS (phosphate buffered saline) in which 5 wt % skim milk was suspended and left to stand at room temperature for 2 hours. Subsequently, an antigen-antibody reaction with mouse IgG2a, which is an antigen, was carried out, and an antigen-antibody reaction with biotinylated antimouse IgG2a, which is a secondary antibody, was then carried out. Finally, a reaction with Cy5-labeled streptavidin was carried out, and a fluorescence intensity measurement was carried out for each spot. The results are given in Table 1.

The measurement of fluorescence intensity in Experimental Example A1 and Experimental Example A2 employed a ‘ScanArray’ microarray scanner manufactured by Packard BioChip Technologies. Measurement conditions were: laser output 90%, PMT sensitivity 60%, excitation wavelength 649 nm, measurement wavelength 670 nm, and resolution 50 μm.

Experimental Example A1 gave stronger spot signal values and lower background values than Experimental Example A2 at all dilution ratios, thus resulting in large S/N ratios.

TABLE 1

| | Dilution | | | | |
|---|---|---|---|---|---|
| | ratio | 10 | 20 | 30 | 40 |
| Exp. | Spot signal | 63,021 | 59,142 | 30,053 | 15,244 |
| Ex. A1 | strength | | | | |
| | Background | 802 | 853 | 750 | 700 |
| | value | | | | |
| | S/N ratio | 78.6 | 147.9 | 40.1 | 21.8 |
| Exp. | Spot signal | 59,002 | 55,200 | 17,334 | 10,842 |
| Ex. A2 | strength | | | | |
| | Background | 1052 | 1109 | 920 | 950 |
| | value | | | | |
| | S/N ratio | 56.1 | 49.8 | 18.8 | 11.4 |

### Experimental Example B1, Experimental Example B2

In Experimental Example B1 and Experimental Example B2, the biochip substrate and the biochip described in the second embodiment were prepared, and detection of an antibody was carried out.

### Experimental Example B1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a macromolecular substance having a phosphorylcholine group and an active ester group was incorporated into the substrate surface.

Subsequently, a sandwich method was carried out on the substrate. In detail, antimouse IgG2a, which is a primary antibody, prepared at a dilution ratio shown in Table 2 so as to give a pH of 8.0 was first spotted on the substrate using an automated spotter and then left to stand in an environment of a room temperature of 4° C. for 24 hours. Following this, mouse IgG2a, which is an antigen, prepared so as to give a pH of 7.0 was applied to the surface of the substrate, an antigen-antibody reaction was carried out, and an antigen-antibody reaction was then carried out with biotinylated antimouse IgG2a, which is a secondary antibody. Finally, a reaction with Cy5-labeled streptavidin was carried out, and a fluorescence intensity measurement was carried out for each spot. The results are given in Table 2.

### Experimental Example B2

The procedure of Experimental Example B1 was repeated except that solutions of antimouse IgG2a, which is a primary antibody, prepared so as to give a pH of 7.0, and mouse IgG2a, which is an antigen, prepared so as to give a pH of 8.0, were used.

The measurement of fluorescence intensity in Experimental Example B1 and Experimental Example B2 employed a ‘ScanArray’ microarray scanner manufactured by Packard BioChip Technologies. Measurement conditions were: laser output 90%, PMT sensitivity 60%, excitation wavelength 649 nm, measurement wavelength 670 nm, and resolution 50 μm.

Experimental Example B1 gave stronger spot signal values and lower background values than Experimental Example B2 at all dilution ratios, thus resulting in large S/N ratios.

TABLE 2

| | Dilution | | | | |
|---|---|---|---|---|---|
| | ratio | 10 | 20 | 30 | 40 |
| Exp. | Spot signal | 63,021 | 59,142 | 30,053 | 15,244 |
| Ex. B1 | strength | | | | |
| | Background | 802 | 853 | 750 | 700 |
| | value | | | | |
| | S/N ratio | 78.6 | 147.9 | 40.1 | 21.8 |
| Exp. | Spot signal | 53,002 | 51,210 | 16,334 | 10,502 |
| Ex. B2 | strength | | | | |
| | Background | 9020 | 8800 | 9530 | 8140 |
| | value | | | | |
| | S/N ratio | 5.88 | 5.82 | 1.71 | 1.29 |

### Experimental Example C1, Experimental Example C2

In Experimental Example C1 and Experimental Example C2, the biochip substrate and the biochip described in the third embodiment were prepared, and detection of an antibody was carried out.

### Experimental Example C1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a macromolecular substance having a phosphorylcholine group and an active ester group was incorporated into the substrate surface.

Subsequently, a sandwich method was carried out on the substrate. In detail, antimouse IgG2a, which is a primary antibody, prepared at a dilution ratio shown in Table 3 so as to give a pH of 8.0 was first spotted on the substrate using an automated spotter and then left to stand in an environment of a room temperature of 4° C. for 24 hours. Following this, mouse IgG2a, which is an antigen, prepared so as to give a pH of 7.0 was applied to the surface of the substrate, an antigen-antibody reaction was carried out, and an antigen-antibody reaction was then carried out with biotinylated antimouse IgG2a, which is a secondary antibody. Finally, a reaction with Cy5-labeled streptavidin was carried out, and a fluorescence intensity measurement was carried out for each spot. The results are given in Table 3.

### Experimental Example C2

The procedure of Experimental Example C1 was repeated except that solutions of antimouse IgG2a, which is a primary antibody, prepared so as to give a pH of 7.0, and mouse IgG2a, which is an antigen, prepared so as to give a pH of 8.0, were used.

The measurement of fluorescence intensity in Experimental Example C1 and Experimental Example C2 employed a ‘ScanArray’ microarray scanner manufactured by Packard BioChip Technologies. Measurement conditions were: laser output 90%, PMT sensitivity 60%, excitation wavelength 649 nm, measurement wavelength 670 nm, and resolution 50 μm.

From Table 3, Experimental Example C1 gave stronger spot signal values and lower background values than Experimental Example C2 at all dilution ratios, thus resulting in large S/N ratios.

TABLE 3

| | Dilution | | | | |
|---|---|---|---|---|---|
| | ratio | 10 | 20 | 30 | 40 |
| Exp. | Spot signal | 63,021 | 59,142 | 30,053 | 15,244 |
| Ex. C1 | strength | | | | |
| | Background | 802 | 853 | 750 | 700 |
| | value | | | | |
| | S/N ratio | 78.6 | 147.9 | 40.1 | 21.8 |
| Exp. | Spot signal | 53,002 | 51,210 | 16,334 | 10,502 |
| Ex. C2 | strength | | | | |
| | Background | 9020 | 8800 | 9530 | 8140 |
| | value | | | | |
| | S/N ratio | 5.88 | 5.82 | 1.71 | 1.29 |

### Experimental Example D1, Experimental Example D2

In Experimental Example D1 and Experimental Example D2, the biochip substrate and the biochip described in the fourth embodiment were prepared, and detection of an antibody was carried out.

### Experimental Example D1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 1 wt % aqueous solution of KBM903 (aminosilane, manufactured by Shin-Etsu Chemical Co., Ltd.), a first layer was formed. By further immersing this substrate in a 0.5 wt % ethanol solution of a 2-methacryloyloxyethyl phosphorylcholine/butyl methacrylate/p-nitrophenylcarbonyloxyethyl methacrylate copolymer, a second layer having a macromolecular substance having a phosphorylcholine group and an active ester group was formed on the substrate surface.

### Experimental Example D2

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a layer having a macromolecular substance having a phosphorylcholine group and an active ester group was formed on the substrate surface.

### Evaluation Experiment

Subsequently, a sandwich method was carried out on each of the substrates obtained. In detail, antimouse IgG2a, which is a primary antibody, prepared at a dilution ratio shown in Table 4 was first spotted on the substrate using an automated spotter and then left to stand in an environment of a room temperature of 4° C. for 24 hours. Following this, by immersing it in a 0.1 N aqueous solution of sodium hydroxide, active ester was deactivated. It was then immersed in a 1.0 wt % aqueous solution of sodium dodecylsulfate for 1 hour.

Following this, an antigen-antibody reaction with mouse IgG2a, which is an antigen, was carried out, and an antigen-antibody reaction was then carried out with biotinylated antimouse IgG2a, which is a secondary antibody. Finally, a reaction with Cy5-labeled streptavidin was carried out, and a fluorescence intensity measurement was carried out for each spot. The results are given in Table 4.

The measurement of fluorescence intensity in Experimental Example D1 and Experimental Example D2 employed a ‘ScanArray’ microarray scanner manufactured by Packard BioChip Technologies. Measurement conditions were: laser output 90%, PMT sensitivity 50%, excitation wavelength 649 nm, measurement wavelength 670 nm, and resolution 50 μm.

As shown in Table 4, in Experimental Example D1, a high spot signal value and a low background value were observed, but in Experimental Example D2 the layer peeled off and a low spot signal value was given. Furthermore, due to the layer peeling off, nonspecific adsorption onto the substrate occurred, and the background value increased.

TABLE 4

| | Dilution | | | | |
|---|---|---|---|---|---|
| | ratio | 10 | 20 | 30 | 40 |
| Exp. | Spot signal | 60,021 | 52,110 | 30,203 | 13,015 |
| Ex. D1 | strength | | | | |
| | Background | 902 | 821 | 730 | 710 |
| | value | | | | |
| Exp. | Spot signal | 2002 | 3,200 | 3,334 | 1,842 |
| Ex. D2 | strength | | | | |
| | Background | 1052 | 1309 | 1920 | 1050 |
| | value | | | | |

### Experimental Example E1, Experimental Example E2

In Experimental Example E1 and Experimental Example E2, the biochip substrate and the biochip described in the fifth embodiment were prepared, and detection of an antibody was carried out.

### Experimental Example E1

A saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) was processed into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a macromolecular substance having a phosphorylcholine group and an active ester group was incorporated into the substrate surface.

Subsequently, a sandwich method was carried out on the substrate. In detail, antimouse IgG2a, which is a primary antibody, prepared at a dilution ratio shown in Table 5 was first spotted on the substrate using an automated spotter and then left to stand in an environment of a room temperature of 4° C. for 24 hours. Following this, by immersing it in a 40 wt % aqueous solution of XTJ-506 (terminal aminated ethylene glycol/propylene glycol copolymer, manufactured by Sun Technochemical Co., Ltd.) as a hydrophilic polymer, the active ester group was converted into a hydrophilic polymer.

### Experimental Example E2

The procedure of Experimental Example E1 was repeated except that a 0.1 N aqueous solution of sodium hydroxide was used instead of the 40 wt % aqueous solution of XTJ-506.

### Evaluation Experiment

An antigen-antibody reaction of each of the biochips of Experimental Example E1 and Experimental Example E2 with mouse IgG2a, which is an antigen, was carried out, and after that an antigen-antibody reaction with biotinylated antimouse IgG2a, which is a secondary antibody, was then carried out. Finally, a reaction with Cy5-labeled streptavidin was carried out, and a fluorescence intensity measurement was carried out for each spot. The results are given in Table 5.

The measurement of fluorescence intensity employed a ‘ScanArray’ microarray scanner manufactured by Packard BioChip Technologies. Measurement conditions were: laser output 90%, PMT sensitivity 60%, excitation wavelength 649 nm, measurement wavelength 670 nm, and resolution 50 μm.

Experimental Example E1 exhibited lower background values than Experimental Example E2 at all dilution ratios, thus giving large S/N ratios.

TABLE 5

| | Dilution | | | | |
|---|---|---|---|---|---|
| | ratio | 10 | 20 | 30 | 40 |
| Exp. | Spot signal | 63,201 | 58,142 | 30,154 | 15,114 |
| Ex. E1 | strength | | | | |
| | Background | 502 | 453 | 450 | 410 |
| | value | | | | |
| | S/N ratio | 125.9 | 128.3 | 67 | 36.9 |
| Exp. | Spot signal | 62,900 | 57,200 | 30,334 | 14,842 |
| Ex. E2 | strength | | | | |
| | Background | 802 | 853 | 750 | 700 |
| | value | | | | |
| | S/N ratio | 78.4 | 67.1 | 40.4 | 21.2 |

### Experimental Example F1 to Experimental Example F3

In Experimental Example F1 to Experimental Example F3, the biochip substrate and the biochip described in the sixth embodiment were prepared, and detection of an antibody was carried out.

### Experimental Example F1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/N-hydroxysuccinimidocarbonyloxyethyl methacrylate copolymer, a macromolecular substance having a phosphorylcholine group and an active ester group was incorporated into the substrate surface.

Subsequently, a sandwich method was carried out on the substrate. In detail, antimouse IgG2a, which is a primary antibody, prepared at a dilution ratio shown in Table 6 was first spotted on the substrate using an automated spotter, and then left to stand in an environment of a room temperature of 4° C. for 24 hours. Following this, by immersing it in a 0.1 N aqueous solution of sodium hydrogen carbonate, active ester was deactivated.

Subsequently, an antigen-antibody reaction with mouse IgG2a, which is an antigen, was carried out, and an antigen-antibody reaction with biotinylated antimouse IgG2a, which is a secondary antibody, was then carried out. Finally, a reaction with Cy5-labeled streptavidin was carried out, and a fluorescence intensity measurement was carried out for each spot. The results are given in Table 6.

### Experimental Example F2

The procedure of Experimental Example F1 was repeated except that a 0.5 wt % ethanol solution of 2-methacryloyloxyethyl phosphorylcholine/butyl methacrylate/p-nitrophenylcarboxyethyl methacrylate copolymer was used.

### Experimental Example F3

In the same manner as in Experimental Example F1, the surface of the substrate was subjected to a hydrophilization treatment, following which it was immersed in a 2 wt % aqueous solution of an amino group-containing alkyl silane, and the surface was then subjected to a thermal treatment so as to incorporate an amino group into the surface. By immersing this in a 1 wt % aqueous solution of glutaraldehyde, the amino group of the surface and glutaraldehyde were reacted to thus incorporate an aldehyde group.

Subsequently, a sandwich method was carried out on the substrate. In detail, antimouse IgG2a, which is a primary antibody, prepared at a dilution ratio shown in Table 6 was first spotted on the substrate using an automated spotter and then left to stand in an environment of a room temperature of 4° C. for 24 hours. Following this, in order to prevent nonspecific adsorption, the substrate was immersed in a 9.6 g/L buffer solution of PBS in which 5 wt % skim milk was suspended and left to stand at room temperature for 2 hours. Following this, an antigen-antibody reaction with mouse IgG2a, which is an antigen, was carried out, and an antigen-antibody reaction with biotinylated antimouse IgG2a, which is a secondary antibody, was then carried out. Finally, a reaction with Cy5-labeled streptavidin was carried out, and a fluorescence intensity measurement was carried out for each spot. The results are given in Table 6.

The measurement of fluorescence intensity in Experimental Examples F1 to F3 employed a ‘ScanArray’ microarray scanner manufactured by Packard BioChip Technologies. Measurement conditions were: laser output 90%, PMT sensitivity 50%, excitation wavelength 649 nm, measurement wavelength 670 nm, and resolution 50 μm.

Experimental Example F1 exhibited a stronger spot signal value and a lower background value than Experimental Example F2 and Experimental Example F3, thus resulting in large S/N ratios.

TABLE 6

| | Dilution | | | | |
|---|---|---|---|---|---|
| | ratio | 10 | 20 | 30 | 40 |
| Exp. | Spot signal | 53,024 | 53,142 | 29,053 | 15,200 |
| Ex. F1 | strength | | | | |
| | Background | 570 | 450 | 450 | 500 |
| | value | | | | |
| | S/N ratio | 79.1 | 66.4 | 52.8 | 30.4 |
| Exp. | Spot signal | 41,100 | 39,001 | 20,210 | 9,239 |
| Ex. F2 | strength | | | | |
| | Background | 750 | 660 | 530 | 620 |
| | value | | | | |
| | S/N ratio | 54.8 | 59.1 | 38.1 | 14.9 |
| Exp. | Spot signal | 42,002 | 43,200 | 15,334 | 9,842 |
| Ex. F3 | strength | | | | |
| | Background | 932 | 997 | 900 | 930 |
| | value | | | | |
| | S/N ratio | 56.1 | 49.8 | 18.8 | 11.4 |

### Experimental Example G1 to Experimental Example G9

In Experimental Example G1 to Experimental Example G9, the biochip substrate and the biochip described in the seventh embodiment were prepared, and detection of an antibody was carried out.

### Experimental Example G1 to G7, Experimental Example G10, Experimental Example G11 Homopolymer

A macromolecular substance having a phosphorylcholine group and an active ester group at a ratio shown in Table 7 was incorporated into a slide substrate of a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)). The solution was 0.5 wt % as an ethanol substrate.

TABLE 7
Homopolymer

| | Phosphorylcholine | Butyl methacrylate | p-Nitrophenyl ester |
|---|---|---|---|
| | group (mol %) | group (mol %) | group (mol %) |
| Exp. | 25 | 57 | 18 |
| Ex. G1 | | | |
| Exp. | 35 | 41 | 24 |
| Ex. G2 | | | |
| Exp. | 15 | 67 | 18 |
| Ex. G3 | | | |
| Exp. | 25 | 70 | 5 |
| Ex. G4 | | | |
| Exp. | 45 | 38 | 17 |
| Ex. G5 | | | |
| Exp. | 30 | 40 | 30 |
| Ex. G6 | | | |
| Exp. | 45 | 20 | 35 |
| Ex. G7 | | | |
| Exp. | 25 | 74 | 1 |
| Ex. G10 | | | |
| Exp. | 25 | 72 | 3 |
| Ex. G11 | | | |

### Experimental Example G8, Experimental Example G9, Experimental Example G12 to G14

The 0.5 wt % ethanol solutions of polymers used in Experimental Example G6 and Experimental Example G7 were each mixed with a 0.5 wt % ethanol solution of an MPC polymer (phosphorylcholine groups 30 mol %, butyl methacrylate groups 70 mol %) to thus adjust the proportion of each of the groups. The mixing proportions and the final compositions are shown in Table 8.

TABLE 8
Blend polymer

| | Proportions | | Butyl | |
|---|---|---|---|---|
| | of | Phosphoryl | methacrylate | p-Nitrophenyl |
| | polymers | choline group | group | ester group |
| | used | (mol %) | (mol %) | (mol %) |
| Exp. | Exp. Ex. | 30 | 55 | 15 |
| Ex. G8 | G6: 50 | | | |
| | MPC: 50 | | | |
| Exp. | Exp. Ex. | 37.5 | 45 | 17.5 |
| Ex. G9 | G7: 50 | | | |
| | MPC: 50 | | | |
| Exp. | Exp. Ex. | 30 | 67 | 3 |
| Ex. G12 | G6: 10 | | | |
| | MPC: 90 | | | |
| Exp. | Exp. Ex. | 31.5 | 65 | 3.5 |
| Ex. G13 | G7: 10 | | | |
| | MPC: 90 | | | |
| Exp. | Exp. Ex. | 30 | 64 | 6 |
| Ex. G14 | G6: 20 | | | |
| | MPC: 80 | | | |

### Evaluation Experiment

Subsequently, a sandwich method was carried out on the substrate. In detail, antimouse IgG2a, which is a primary antibody, prepared at a dilution ratio shown in Table 9 was first spotted on the substrate using an automated spotter, and then left to stand in an environment of a room temperature of 4° C. for 24 hours. Following this, by immersing it in a 0.1 N aqueous solution of sodium hydroxide, the active ester group was treated.

The biochips of Experimental Examples G1 to G14 were further subjected to an antigen-antibody reaction with mouse IgG2a, which is an antigen, and then to an antigen-antibody reaction with biotinylated antimouse IgG2a, which is a secondary antibody. Finally, a reaction with Cy5-labeled streptavidin was carried out, and a fluorescence intensity measurement was carried out for each spot. The results are given in Table 9.

The measurement of fluorescence intensity employed a ‘ScanArray’ microarray scanner manufactured by Packard BioChip Technologies. Measurement conditions were: laser output 90%, PMT sensitivity 45%, excitation wavelength 649 nm, measurement wavelength 670 nm, and resolution 50 μm.

From Table 9, Experimental Example G4, and Experimental Examples G10 to G14 exhibited particularly low background values, thus resulting in larger S/N ratios.

TABLE 9

| | Spot signal strength | Background value | S/N ratio |
|---|---|---|---|
| Exp. | 14032 | 340 | 41.3 |
| Ex. G1 | | | |
| Exp. | 21210 | 502 | 42.3 |
| Ex. G2 | | | |
| Exp. | 12240 | 401 | 30.5 |
| Ex. G8 | | | |
| Exp. | 10022 | 300 | 33.4 |
| Ex. G9 | | | |
| Exp. | 20943 | 3050 | 6.9 |
| Ex. G3 | | | |
| Exp. | 18072 | 97 | 186.3 |
| Ex. G4 | | | |
| Exp. | 1050 | 250 | 4.2 |
| Ex. G5 | | | |
| Exp. | 20509 | 300 | 68.4 |
| Ex. G6 | | | |
| Exp. | 500 | 150 | 3.3 |
| Ex. G7 | | | |
| Exp. | 10112 | 90 | 112.4 |
| Ex. G10 | | | |
| Exp. | 15292 | 93 | 164.4 |
| Ex. G11 | | | |
| Exp. | 14012 | 90 | 155.7 |
| Ex. G12 | | | |
| Exp. | 16931 | 95 | 178.2 |
| Ex. G13 | | | |
| Exp. | 18022 | 97 | 185.8 |
| Ex. G14 | | | |

### Experimental Example H1, Experimental Example H2

In Experimental Example H1 and Experimental Example H2, the biochip substrate and the biochip described in the eighth embodiment were prepared, and hybridization of DNA was carried out.

### Experimental Example H1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 0.5 wt % ethanol solution of 2-methacryloyloxyethyl phosphorylcholine/butyl methacrylate/p-nitrophenylcarbonyloxyethyl methacrylate copolymer, a macromolecular substance having a phosphorylcholine group and an active ester group was incorporated into the substrate surface.

### Experimental Example H2

After a substrate similar to one used in Experimental Example H1 was immersed in a 2 vol % ethanol solution of 3-aminopropyltrimethoxysilane, it was washed with pure water and subjected to a thermal treatment to thus incorporate an amino group. By immersing the substrate having the incorporated amino group in a 1 vol % aqueous solution of glutaraldehyde and washing it with pure water, an aldehyde group was incorporated.

### Preparation of DNA Solution

As DNA solution 1 and DNA solution 2, the solutions below were prepared.

DNA solution 1: oligo DNA (TAGAAGCATTTGCGGTGGACGATG (SEQ ID NO:1) (manufactured by SIGMA Genosys) having an amino group at the 5′ terminal and a chain length of 24 bp was dissolved in a certain buffer solution to give a concentration of 0.1 μg/μL.

DNA solution 2: oligo DNA (CATCGTCCACCGCAAATGCTTCTA (SEQ ID NO:2) (manufactured by SIGMA Genosys) having its 5′ terminal Cy3-labeled and a chain length of 24 bp was dissolved in a 3×SSC (standard saline citrate), 0.2 wt % SDS (sodium dodecylsulfate) solution to give a concentration of 0.002 μg/μL.

### Spotting and Hybridization

In Experimental Example H1, DNA solution 1 was dispensed into a 96-well plate and spotted on the substrate using a micropin type microarray spotter. After completion of the spotting, the substrate was left to stand in an oven at 80° C.

Following this, a blocking treatment was carried out by immersing it in a 0.1 N solution of sodium hydroxide for 5 min. so as to deactivate active ester groups. Subsequently, DNA solution 2 was spread out on the substrate, and it was covered with a cover glass and allowed to stand within a high humidity container at 65° C. for 3 hours to thus carry out hybridization of the immobilized oligo DNA and Cy3-labeled oligo DNA. It was then washed in 2×SSC and 0.5 wt % SDS, followed by washing with pure water to thus prepare a post-DNA hybridization substrate.

In Experimental Example H2, in the same manner as in Experimental Example H1, DNA solution 1 was dispensed into a 96-well plate and spotted on the substrate using a micropin type microarray spotter. After completion of the spotting, it was left to stand in an oven at 80° C.

Following this, by immersing it in a 0.5 wt % PBS solution of sodium borohydride for 5 min., excess aldehyde groups were blocked. DNA solution 2 was spread out on this substrate, and it was covered with a cover glass and allowed to stand within a high humidity container at 65° C. for 3 hours to thus carry out hybridization of the immobilized oligo DNA and Cy3-labeled oligo DNA. It was then washed in 2×SSC and 0.5 wt % SDS, followed by washing with pure water to thus prepare a post-DNA hybridization substrate.

### Evaluation Experiment

The measurement of autofluorescence intensity in Experimental Example H1 and Experimental Example H2 employed a ‘ScanArray’ microarray fluorescence scanner (manufactured by Packard BioChip Technologies). Measurement conditions were: laser output 90%, PMT sensitivity 70%, excitation wavelength 550 nm, and measurement wavelength 570 nm. The results obtained by converting a scanned image obtained using the ScanArray into numerical values as a substrate fluorescence intensity using ‘QuantArray’ analysis software included with the scanner are given in Table 10.

For the measurement of a fluorescence count value and a background value after DNA hybridization, the fluorescence of a spot was detected using a ‘ScanArray Lite’ microarray scanner (manufactured by Packard BioChip Technologies). Measurement conditions were: laser output 90%, PMT sensitivity 45%, excitation wavelength 550 nm, and measurement wavelength 570 nm. The results obtained by converting the fluorescence intensity of the spot into a numerical value using ‘QuantArray’ analysis software included with the scanner are given in Table 10.

In the results for Experimental Example H1, the autofluorescence was low compared with Experimental Example H2. Furthermore, with regard to the post-DNA hybridization fluorescence count value, the results for Experimental Example H1 were superior. These results support the effects of the present invention.

TABLE 10

| | Auto- | Auto- | | |
|---|---|---|---|---|
| | fluorescence | fluorescence | | |
| | value of | value of | Fluorescence | Background |
| | substrate | substrate | count | value |
| | after | surface | after DNA | after DNA |
| | molding | treatment | hybridization | hybridization |
| Exp. | 1150 | 1200 | 32000 | 70 |
| Ex. H1 | | | | |
| Exp. | 1150 | 4200 | 26000 | 580 |
| Ex. H2 | | | | |

### Experimental Example I1 to Experimental Example I5

In Experimental Example I1 to Experimental Example I5, the biochip substrate and the biochip described in the ninth embodiment were prepared, and detection of an antibody was carried out.

### Experimental Example I1

A substrate was prepared by processing a saturated cyclic polyolefin resin (hydrogenated ring-opening polymer of 5-methyl-2 norbornene (MFR: 21 g/10 min., degree of hydrogenation: substantially 100%, thermal deformation temperature 123° C.)) into the shape of a slide glass (dimensions: 76 mm×26 mm×1 mm). By immersing the substrate in a 1 wt % mixed ethanol/water solution of (3-acryloxypropyl)trimethoxysilane, a first layer was formed. By further immersing this substrate in an ethanol solution of 2-methacryloxyethyl phosphorylcholine (0.1 mol/L), p-nitrophenylcarbonyloxyethyl methacrylate (0.1 mol/L), and the radical initiator azobisisobutyronitrile (0.01 mol/L), and heating at 65° C. for 4 hours, a second layer having a phosphorylcholine group and an active ester group was formed on the substrate surface.

### Experimental Example I2

The procedure of Experimental Example I1 was repeated except that for formation of the first layer methacryloxypropyltrimethoxysilane was used instead of (3-acryloxypropyl)trimethoxysilane, and a second layer having a phosphorylcholine group and an active ester group was formed on the substrate surface.

### Experimental Example I3

A substrate was prepared by processing a saturated cyclic polyolefin resin into the shape of a slide glass (dimensions: 76 mm×26 mm×1 mm). By immersing the substrate in a 1 wt % mixed ethanol/water solution of vinyltriethoxysilane, a first layer was formed. By further immersing this substrate in an ethanol solution of 2-methacryloxyethyl phosphorylcholine (0.1 mol/L), p-nitrophenylcarbonyloxyethyl methacrylate (0.1 mol/L), and the photoinitiator 1-[4-(2-hydroxyethoxy)-phenyl]-2-hydroxy-2-methyl-1-propan-1-one (0.01 mol/L), and irradiating it with ultraviolet rays at 250 nm to 400 nm for 2 hours, a second layer having a phosphorylcholine group and an active ester group was formed on the substrate surface.

### Experimental Example I4

The procedure of Experimental Example I3 was repeated except that allyltriethoxysilane was used for formation of the first layer, and a second layer having a phosphorylcholine group and an active ester group was formed on the substrate surface.

### Experimental Example I5

A substrate was prepared by processing a saturated cyclic polyolefin resin into the shape of a slide glass (dimensions: 76 mm×26 mm×1 mm). By immersing the substrate in a 0.5 wt % ethanol solution of a 2-methacryloyloxyethyl phosphorylcholine/butyl methacrylate/p-nitrophenylcarbonyloxyethyl methacrylate copolymer, a layer having a macromolecular substance having a phosphorylcholine group and an active ester group was formed on the substrate surface.

### Evaluation Experiment

Subsequently, a sandwich method was carried out on the substrate. In detail, antimouse IgG2a, which is a primary antibody, prepared at a dilution ratio shown in Table 11 was first spotted on the substrate using an automated spotter, and then left to stand in an environment of a room temperature of 4° C. for 24 hours. Subsequently, by immersing it in 0.1 N aqueous solution of sodium hydroxide, active ester groups were deactivated. Subsequently, it was immersed in a 1.0 wt % aqueous solution of sodium dodecylsulfate for 1 hour.

Subsequently, an antigen-antibody reaction with mouse IgG2a, which is an antigen, was carried out, and an antigen-antibody reaction with biotinylated antimouse IgG2a, which is a secondary antibody, was then carried out. Finally, a reaction with Cy5-labeled streptavidin was carried out, and a fluorescence intensity measurement was carried out for each spot. The results are given in Table 11.

The measurement of fluorescence intensity in Experimental Example I1 to Experimental Example I5 employed a ‘ScanArray’microarray scanner manufactured by Packard BioChip Technologies. Measurement conditions were: laser output 90%, PMT sensitivity 60%, excitation wavelength 649 nm, measurement wavelength 670 nm, and resolution 50 μm.

In Experimental Example I1 to Experimental Example I4, high spot signal values and low background values were observed, but in Experimental Example I5 the layer peeled off and a low spot signal value was exhibited. Furthermore, due to the layer peeling off nonspecific adsorption on the substrate occurred and the background value therefore increased.

TABLE 11

| | Dilution | | | | |
|---|---|---|---|---|---|
| | ratio | 10 | 20 | 30 | 40 |
| Exp. | Spot signal | 63,021 | 59,142 | 30,053 | 15,244 |
| Ex. I1 | strength | | | | |
| | Background | 1,020 | 1,130 | 1,090 | 950 |
| | value | | | | |
| Exp. | Spot signal | 60,031 | 57,140 | 31,002 | 15,200 |
| Ex. I2 | strength | | | | |
| | Background | 1,110 | 1,120 | 1,110 | 1,002 |
| | value | | | | |
| Exp. | Spot signal | 64,021 | 60,142 | 39,020 | 18,201 |
| Ex. I3 | strength | | | | |
| | Background | 1,201 | 925 | 902 | 1,120 |
| | value | | | | |
| Exp. | Spot signal | 57,210 | 56,128 | 25,063 | 9,689 |
| Ex. I4 | strength | | | | |
| | Background | 1,524 | 1,420 | 1,350 | 1,100 |
| | value | | | | |
| Exp. | Spot signal | 4,002 | 4,200 | 4,334 | 3,842 |
| Ex. I5 | strength | | | | |
| | Background | 3,052 | 3,309 | 3,320 | 3,050 |
| | value | | | | |

### Experimental Example J1 to J6

In these Experimental Examples, the biochip substrate and the biochip described in the tenth embodiment were prepared, and hybridization of DNA and detection of an antibody were carried out.

### Preparation of Solutions

In the present Experimental Examples, as DNA solutions 1 and 2, an antibody solution, an antigen solution, and blocking solutions 1 to 3, the solutions below were prepared.

DNA solution 1: oligo DNA (TAGAAGCATTTGCGGTGGACGATG (SEQ ID NO:1) having an amino group at the 5′ terminal and a chain length of 24 bp (manufactured by SIGMA Genosys) was dissolved in a certain buffer solution to give a concentration of 0.1 μg/μL.
DNA solution 2: oligo DNA (CATCGTCCACCGCAAATGCTTCTA (SEQ ID NO:2) having a Cy3-labeled 5′ terminal and a chain length of 24 bp (manufactured by SIGMA Genosys) was dissolved in a 3×SSC, 0.2 wt % SDS solution to give a concentration of 0.002 μg/μL.
Antibody solution: antimouse IgG2a antibody (rabbit-derived) was dissolved in PBS to give a concentration of 0.1 mg/mL.
Antigen solution: mouse IgG2a antibody was dissolved in FBS to give a concentration of 1 μg/mL, 100 μL of this FBS containing mouse IgG2a antibody was added to 1 mL of a carbonate buffer having a pH of 9.5, 10 μL of a solution in which NHS-modified Cy3 had been dissolved in ultrapure water to give a concentration of 1 mg/mL was further added, the mixture was allowed to stand at 25° C. for 2 hours, and unreacted NHS-modified Cy3 was removed by a gel filtration column to thus give a solution containing Cy3-labeled mouse IgG2a and FBS-derived protein in PBS.
Blocking solution 1: a 0.1 N solution of sodium hydroxide was prepared.
Blocking solution 2: sodium borohydride was dissolved in PBS to give a concentration of 0.5 wt %.
Blocking solution 3: BSA was dissolved in PBS to give a concentration of 1 wt %.

### Experimental Example J1

A polystyrene resin substrate having a groove with a width of 150 μm and a depth of 100 μm and through holes provided at ends of the groove and having a diameter of 1 mm was molded by injection molding. Furthermore, a flat-plate substrate of a polystyrene resin having the same dimensions as those of the above substrate was molded.

The face with the groove of the substrate having the groove formed thereon, and one face of the flat-plate substrate were coated with a 0.5 wt % ethanol solution of a 2-methacryloyloxyethyl phosiphorylcholine/butyl methacrylate/p-nitrophenylcarbonyloxyethyl methacrylate copolymer and dried, thus incorporating a macromolecular substance having a phosphorylcholine group and an active ester group.

DNA solution 1 was spotted onto a bottom part of the groove using a microarray spotting pin having a diameter of 100 μm, and after spotting it was allowed to stand overnight while maintaining the humidity. Following this, by joining the face of the flat substrate coated with the resin and the face on which the groove was formed of the substrate having the groove, and bonding the substrates by ultrasonic welding, a substrate through which a fluid could flow was prepared. After blocking solution 1 was injected via the hole provided at the end of the groove so as to fill the interior of the channel it was allowed to stand for 10 min. so as to deactivate active ester groups within the channel, and an evaluation by DNA hybridization was carried out.

### Experimental Example J2

A polystyrene resin substrate having a groove with a width of 150 μm and a depth of 100 μm and through holes provided at ends of the groove and having a diameter of 1 mm was molded by injection molding. Furthermore, a flat-plate substrate having the same dimensions as those of the above substrate was molded.

The face with the groove of the substrate having the groove formed thereon, and one face of the flat-plate substrate were coated with a 0.5 wt % ethanol solution of a 2-methacryloyloxyethyl phosiphorylcholine/butyl methacrylate/p-nitrophenylcarbonyloxyethyl methacrylate copolymer and dried, thus incorporating a macromolecular substance having a phosphorylcholine group and an active ester group.

The antibody solution was spotted onto a bottom part of the groove using a microarray spotting pin having a diameter of 100 μm, and after spotting it was allowed to stand overnight while maintaining the humidity. Following this, by joining the face of the flat substrate coated with the resin and the groove side and bonding the substrates by ultrasonic welding, a substrate through which a fluid could flow was prepared. After blocking solution 1 was injected via the hole provided at the end of the groove so as to fill the interior of the channel it was allowed to stand for 10 min. so as to deactivate active ester groups within the channel, and an evaluation by an antigen-antibody reaction was carried out.

### Experimental Example J3

As polystyrene resin substrates, a substrate having a groove with a width of 150 μm and a depth of 100 μm and through holes provided at ends of the groove and having a diameter of 1 mm, and a flat-plate substrate having the same dimensions as those of the above substrate were molded by injection molding. After the surfaces of the two substrates were subjected to a hydrophilization treatment and then immersed in a 2 wt % solution of an aminoalkylsilane, they were subjected to a thermal treatment, thus incorporating an amino group into the surfaces of the two substrates. By immersing them in a 1 wt % aqueous solution of glutaraldehyde, the amino group of the substrate surface and glutaraldehyde were reacted to thus incorporate an aldehyde group. DNA solution 1 was spotted onto a bottom part of the groove using a microarray spotting pin having a diameter of 100 μm, and after spotting it was allowed to stand overnight while maintaining the humidity. Subsequently, by joining the face of the flat substrate coated with the resin and the groove side and bonding the substrates by ultrasonic welding, a substrate through which a fluid could flow was prepared. After blocking solution 2 was injected via the hole provided at the end of the groove so as to fill the interior of the channel it was allowed to stand for 10 min. so as to deactivate active ester groups within the channel, and an evaluation by DNA hybridization was carried out.

### Experimental Example J4

As polystyrene resin substrates, a substrate having a groove with a width of 150 μm and a depth of 100 μm and through holes provided at ends of the groove and having a diameter of 1 mm, and a flat-plate substrate having the same dimensions as those of the above substrate were molded by injection molding. After the surfaces of the two substrates were subjected to a hydrophilization treatment and then immersed in a 2 wt % solution of an aminoalkylsilane, they were subjected to a thermal treatment, thus incorporating an amino group into the surfaces of the two substrates. By immersing them in a 1 wt % aqueous solution of glutaraldehyde, the amino group of the substrate surface and glutaraldehyde were reacted to thus incorporate an aldehyde group.

The antibody solution was spotted onto a bottom part of the groove using a microarray spotting pin having a diameter of 100 μm, and after spotting it was allowed to stand overnight while maintaining the humidity. Subsequently, by joining the face of the flat substrate coated with the resin and the groove side and bonding the substrates by ultrasonic welding, a substrate through which a fluid could flow was prepared. After blocking solution 2 was fed at a speed of 2 μL/min. for 10 min. via the hole provided at the end of the groove, blocking solution 3 was fed at a speed of 2 μL/min. for 10 min., finally PBS was fed, and an evaluation by an antigen-antibody reaction was carried out.

### Experimental Example J5

As polystyrene resin substrates, a substrate having a groove with a width of 150 μm and a depth of 100 μm and through holes provided at ends of the groove and having a diameter of 1 mm, and a flat-plate substrate having the same dimensions as those of the above substrate were molded by injection molding. After the surfaces of the two substrates were subjected to a hydrophilization treatment and then immersed in a 2 wt % solution of an aminoalkylsilane, they were subjected to a thermal treatment, thus incorporating an amino group into the surfaces of the two substrates. By immersing them in a 1 wt % aqueous solution of glutaraldehyde, the amino group of the substrate surface and glutaraldehyde were reacted to thus incorporate an aldehyde group.

The antibody solution was spotted onto a bottom part of the groove using a microarray spotting pin having a diameter of 100 μm, and after spotting it was allowed to stand overnight while maintaining the humidity. Subsequently, by joining the face of the flat substrate coated with the resin and the groove side and bonding the substrates by ultrasonic welding, a substrate through which a fluid could flow was prepared. Blocking solution 2 was fed at a speed of 2 μL/min. for 10 min. via the hole provided at the end of the groove, finally PBS was fed, and an evaluation by an antigen-antibody reaction was carried out.

### Experimental Example J6

As polystyrene resin substrates, a substrate having a groove with a width of 150 μm and a depth of 100 μm and through holes provided at ends of the groove and having a diameter of 1 mm, and a flat-plate substrate having the same dimensions as those of the above substrate were molded by injection molding. The surfaces of the two substrates were subjected to a hydrophilization treatment.

The antibody solution was spotted onto a bottom part of the groove using a microarray spotting pin having a diameter of 100 μm, and after spotting it was allowed to stand overnight while maintaining the humidity. Subsequently, by joining the face of the flat substrate coated with the resin and the groove side and bonding the substrates by ultrasonic welding, a substrate through which a fluid could flow was prepared. Blocking solution 3 was fed at a speed of 2 μL/min. for 10 min. via the hole provided at the end of the groove, finally PBS was fed, and an evaluation by an antigen-antibody reaction was carried out.

### Evaluation Experiment Involving DNA Hybridization

An evaluation was carried out using Experimental Example J1 and Experimental Example J3. After DNA solution 2 was fed via an injection hole at a speed of 2 μL/min. for 1 min., 3 min., 5 min., and 10 min., washing was carried out by feeding PBS (-) at a speed of 5 μL/min. for 10 min., ultrapure water was then fed, and following this fluorescence (Cy3) in the channel from the DNA spot area and an area other than the spot was measured using a ‘ScanArray Lite’ microarray scanner (manufactured by Packard BioChip Technologies). Measurement conditions were: laser output 90%, PMT sensitivity 45%, excitation wavelength 550 nm, and measurement wavelength 570 nm. The results obtained by converting the fluorescence intensity of the spot into a numerical value using ‘QuantArray’ analysis software included with the scanner are given in Table 12 and Table 13.

### Evaluation Experiment Involving Antigen-Antibody Reaction

An evaluation was carried out using Experimental Example J2, Experimental Example J4, Experimental Example J5, and Experimental Example J6. After the antigen solution was fed via an injection hole at a speed of 2 μL/min. for 1 min., 3 min., 5 min., and 10 min., washing was carried out by feeding PBS (-) at a speed of 5 μL/min. for 10 min., ultrapure water was then fed, and following this fluorescence (Cy3) in the channel from the DNA spot area and an area other than the spot was measured using a microarray scanner. The results are given in Table 14 and Table 15.

In the Experimental Examples above, Experimental Examples in which the material for the substrate was a plastic were illustrated, but when the material for the substrate was a glass, it was also possible to improve detection sensitivity by using the macromolecular substance having a phosphorylcholine group and an active ester group on the substrate surface.

TABLE 12

| DNA solution | Fluorescence strength of area other than spot | |
|---|---|---|
| feed time | Exp. Ex. J1 | Exp. Ex. J3 |
| 1 min. | 450 | 1203 |
| 3 min. | 455 | 1424 |
| 5 min. | 479 | 1591 |
| 10 min. | 501 | 1705 |

TABLE 13

| DNA solution feed | Fluorescence strength of spot area | |
|---|---|---|
| time | Exp. Ex. J1 | Exp. Ex. J3 |
| 1 min. | 21256 | 2796 |
| 3 min. | 23121 | 4225 |
| 5 min. | 23222 | 5521 |
| 10 min. | 23521 | 7215 |

TABLE 14

| Antigen | | | | |
|---|---|---|---|---|
| solution | Fluorescence strength of area other than spot | | | |
| feed time | Exp. Ex. J2 | Exp. Ex. J4 | Exp. Ex. J5 | Exp. Ex. J6 |
| 1 min. | 851 | 1511 | 2026 | 1218 |
| 3 min. | 876 | 2035 | 3260 | 1876 |
| 5 min. | 913 | 3011 | 4315 | 2517 |
| 10 min. | 1001 | 3120 | 7516 | 2745 |

TABLE 15

| Antigen | | | | |
|---|---|---|---|---|
| solution | Fluorescence strength of spot area | | | |
| feed time | Exp. Ex. J2 | Exp. Ex. J4 | Exp. Ex. J5 | Exp. Ex. J6 |
| 1 min. | 8571 | 3274 | 3121 | 1507 |
| 3 min. | 8787 | 4095 | 4325 | 2798 |
| 5 min. | 9035 | 5921 | 6160 | 4052 |
| 10 min. | 9295 | 8120 | 8521 | 5877 |

Modes for carrying out the present invention are listed below.

(1-1) A biochip substrate for immobilizing a biologically active substance on the surface of a solid phase substrate, the substrate surface having a macromolecular substance having a phosphorylcholine group and an active ester group.
(1-2) The biochip substrate as set forth in (1-1), wherein the phosphorylcholine group is 2-methacryloyloxyethyl phosphorylcholine.
(1-3) The biochip substrate as set forth in (1-1) or (1-2), wherein the active ester group is a p-nitrophenyl ester group.
(1-4) The biochip substrate as set forth in any one of (1-1) to (1-3), wherein the macromolecular substance is a copolymer containing a butyl methacrylate group.
(1-5) The biochip substrate as set forth in any one of (1-1) to (1-4), wherein the solid phase substrate is made of a plastic.
(1-6) The biochip substrate as set forth in (1-5), wherein the plastic is a saturated cyclic polyolefin.
(1-7) The biochip substrate as set forth in any one of (1-1) to (1-4), wherein the solid phase substrate is made of a glass.
(1-8) A process for producing a biochip, the process including immobilizing a biologically active substance on the biochip substrate as set forth in any one of (1-1) to (1-7), and deactivating active ester groups of the substrate surface other than those on which the biologically active substance is immobilized.
(1-9) The process for producing a biochip as set forth in (1-8), wherein the deactivation of the active ester groups is carried out using an alkaline compound.
(1-10) The process for producing a biochip as set forth in (1-8), wherein the deactivation of the active ester groups is carried out using a compound having a primary amino group.
(1-11) The process for producing a biochip as set forth in (1-10), wherein the compound having a primary amino group is aminoethanol or glycine.
(1-12) The process for producing a biochip as set forth in any one of (1-8) to (1-11), wherein the biologically active substance is at least one of a nucleic acid, a protein, an oligopeptide, a sugar chain, and a glycoprotein.
(1-13) A biochip produced by the process for producing a biochip as set forth in any one of (1-8) to (1-12).
(2-1) A biochip that includes a substrate having on its surface a macromolecular layer having a phosphocholine group and an active ester group, a molecule for capturing a biologically active substance being immobilized on the surface of the substrate via the active ester group.
(2-2) The biochip as set forth in (2-1), wherein the phosphorylcholine group is a 2-methacryloyloxyethyl phosphorylcholine group.
(2-3) The biochip as set forth in (2-1) or (2-2), wherein the active ester group is a p-nitrophenyl ester group.
(2-4) The biochip as set forth in any one of (2-1) to (2-3), wherein the macromolecular substance is a copolymer containing a butyl methacrylate group.
(2-5) The biochip as set forth in any one of (2-1) to (2-4), wherein a solid phase substrate is made of a plastic.
(2-6) The biochip as set forth in (2-5), wherein the plastic is a saturated cyclic polyolefin.
(2-7) The biochip as set forth in any one of (2-1) to (2-4), wherein a solid phase substrate is made of a glass.
(2-8) The biochip as set forth in any one of (2-1) to (2-7), wherein the molecule for capturing a biologically active substance is at least one of a nucleic acid, a protein, an oligopeptide, a sugar chain, and a glycoprotein.
(2-9) The biochip as set forth in any one of (2-1) to (2-8), wherein the immobilization of the molecule for capturing a biologically active substance is carried out at a pH of equal to or greater than 7.6.
(2-10) The biochip as set forth in any one of (2-1) to (2-9) wherein, further, a biologically active substance is captured.
(2-11) The biochip as set forth in (2-10), wherein the biologically active substance is at least one of a nucleic acid, a protein, an oligopeptide, a sugar chain, and a glycoprotein.
(2-12) A process for producing the biochip of (2-10) or (2-11), the process including contacting the substrate surface with a solution containing a biologically active substance and having a pH of not greater than 7.6.
(3-1) A method for using a biochip substrate having on the surface of a substrate a macromolecular substance having a phosphorylcholine group and an active ester group, the method including (1) immobilizing at a pH of equal to or greater than 7.6 a capture molecule, which is a molecule for capturing a biologically active substance, and (2) contacting the substrate surface with a solution containing a biologically active substance to be detected and having a pH of not greater than 7.6 so as to make the capture molecule capture the biologically active substance.
(3-2) The method for using a biochip substrate as set forth in (3-1), wherein the phosphorylcholine group is a 2-methacryloyloxyethyl phosphorylcholine group.
(3-3) The method for using a biochip substrate as set forth in (3-1) or (3-2), wherein the active ester group is a p-nitrophenyl ester group.
(3-4) The method for using a biochip substrate as set forth in any one of (3-1) to (3-3), wherein the macromolecular substance is a copolymer containing a butyl methacrylate group.
(3-5) The method for using a biochip substrate as set forth in any one of (3-1) to (3-4), wherein the capture molecule is at least one of a nucleic acid, a protein, an oligopeptide, a sugar chain, and a glycoprotein.
(3-6) The method for using a biochip substrate as set forth in any one of (3-1) to (3-5), wherein the biologically active substance to be detected is at least one of a nucleic acid, a protein, an oligopeptide, a sugar chain, and a glycoprotein.
(4-1) A biochip substrate for immobilizing a biologically active substance on the surface of a solid phase substrate, the biochip substrate including on the substrate surface a layer A containing a compound having an amino group and a layer B containing a macromolecular substance having a phosphorylcholine group and an active ester group, the substrate, the layer A, and the layer B being layered in that order.
(4-2) The biochip substrate as set forth in (4-1), wherein some or all of the amino groups of the layer A react with the active ester group of the layer B to form a covalent bond.
(4-3) The biochip substrate as set forth in (4-1) or (4-2), wherein some of the active ester groups of the layer B react with the amino groups of the layer A to form a covalent bond.
(4-4) The biochip substrate as set forth in any one of (4-1) to (4-3), wherein the layer A contains an aminosilane.
(4-5) The biochip substrate as set forth in any one of (4-1) to (4-4), wherein the phosphorylcholine group is a 2-methacryloyloxyethyl phosphorylcholine group.
(4-6) The biochip substrate as set forth in any one of (4-1) to (4-5), wherein the active ester group is a p-nitrophenyl ester group.
(4-7) The biochip substrate as set forth in any one of (4-1) to (4-6), wherein the macromolecular substance is a copolymer containing a butyl methacrylate group.
(4-8) The biochip substrate as set forth in any one of (4-1) to (4-7), wherein the solid phase substrate is made of a plastic.
(4-9) The biochip substrate as set forth in (4-8), wherein the plastic is a saturated cyclic polyolefin.
(4-10) The biochip substrate as set forth in any one of (4-1) to (4-7), wherein the solid phase substrate is made of a glass.
(4-11) A process for producing the biochip substrate as set forth in any one of (4-1) to (4-10), the process including (1) contacting the substrate surface with a compound having an amino group, and (2) contacting with a macromolecular substance having a phosphorylcholine group and an active ester group.
(5-1) A biochip that includes a biochip substrate having on a substrate surface a macromolecular substance having a phosphorylcholine group and an active ester group, a biologically active substance being immobilized on the substrate by reacting with the active ester group, and a hydrophilic group-containing polymer being incorporated into active ester groups of the substrate surface other than those on which the biologically active substance is immobilized.
(5-2) The biochip as set forth in (5-1), wherein the hydrophilic polymer is a hydrophilic polymer having an amino group.
(5-3) The biochip as set forth in (5-1) or (5-2), wherein the hydrophilic polymer contains in its structure any one of a polyalkylene oxide, polyethylene oxide, polypropylene oxide, and a copolymer thereof.
(5-4) The biochip as set forth in any one of (5-1) to (5-3), wherein the phosphorylcholine group is a 2-methacryloyloxyethyl phosphorylcholine group.
(5-5) The biochip as set forth in any one of (5-1) to (5-4), wherein the active ester group is a p-nitrophenyl ester group.
(5-6) The biochip as set forth in any one of (5-1) to (5-5), wherein the macromolecular substance is a polymer containing a butyl methacrylate group.
(5-7) The biochip as set forth in any one of (5-1) to (5-6), wherein a solid phase substrate is made of a plastic.
(5-8) The biochip as set forth in (5-7), wherein the plastic is a saturated cyclic polyolefin.
(5-9) The biochip as set forth in any one of (5-1) to (5-6), wherein a solid phase substrate is made of a glass.
(5-10) The biochip as set forth in any one of (5-1) to (5-9), wherein the biologically active substance is at least one of a nucleic acid, a protein, an oligopeptide, a sugar chain, and a glycoprotein.
(5-11) A process for producing the biochip as set forth in any one of (5-1) to (5-10), the process including immobilizing a biologically active substance on a biochip substrate having on a substrate surface a macromolecular substance having a phosphorylcholine group and an active ester group, and incorporating a polymer having a hydrophilic group into active ester groups of the substrate surface other than those on which the biologically active substance is immobilized.
(6-1) A biochip substrate for immobilizing a biologically active substance on the surface of a solid phase substrate, the biochip substrate including on the substrate surface a macromolecular substance having a phosphorylcholine group and an N-hydroxysuccinimide ester.
(6-2) The biochip substrate as set forth in (6-1), wherein the phosphorylcholine group is 2-methacryloyloxyethyl phosphorylcholine.
(6-3) The biochip substrate as set forth in (6-1) or (6-2), wherein the macromolecular substance is a copolymer containing a butyl methacrylate group.
(6-4) The biochip substrate as set forth in any one of (6-1) to (6-3), wherein the solid phase substrate is made of a plastic.
(6-5) The biochip substrate as set forth in (6-4), wherein the plastic is a saturated cyclic polyolefin.
(6-6) The biochip substrate as set forth in any one of (6-1) to (6-3), wherein the solid phase substrate is made of a glass.
(6-7) A process for producing a biochip, the process including immobilizing a biologically active substance on the biochip substrate as set forth in any one of (6-1) to (6-6), and deactivating active ester groups of the substrate surface other than those on which the biologically active substance is immobilized.
(6-8) The process for producing a biochip as set forth in (6-7), wherein the deactivation of active ester groups is carried out using an alkaline compound.
(6-9) The process for producing a biochip as set forth in (6-7), wherein the deactivation of active ester groups is carried out using a compound having a primary amino group.
(6-10) The process for producing a biochip as set forth in (6-9), wherein the compound having a primary amino group is aminoethanol or glycine.
(6-11) The process for producing a biochip as set forth in any one of (6-7) to (6-10), wherein the biologically active substance is at least one of a nucleic acid, an aptamer, a protein, an oligopeptide, a sugar chain, and a glycoprotein.
(6-12) A biochip produced by the process for producing a biochip as set forth in any one of (6-7) to (6-11).
(7-1) A biochip that includes on the surface of a substrate either a macromolecular substance having a phosphorylcholine group and an active ester group, or a mixed polymer of the macromolecular substance and a polymer formed from a phosphorylcholine group and a butyl methacrylate group.
(7-2) The biochip as set forth in (7-1), wherein the proportion of the phosphorylcholine group contained in the macromolecular substance or the mixed polymer is at least 20 mol % but less than 40 mol %.
(7-3) The biochip as set forth in (7-1) or (7-2), wherein the proportion of the active ester group contained in the macromolecular substance or the mixed polymer is at least 15 mol % but less than 25 mol %.
(7-4) The biochip as set forth in any one of (7-1) to (7-3), wherein the phosphorylcholine group is a 2-methacryloyloxyethyl phosphorylcholine group.
(7-5) The biochip as set forth in any one of (7-1) to (7-4), wherein the active ester group is a p-nitrophenyl ester group or an N-hydroxysuccinimide ester.
(7-6) The biochip as set forth in any one of (7-1) to (7-5), wherein the macromolecular substance is a copolymer containing a butyl methacrylate group.
(7-7) The biochip as set forth in any one of (7-1) to (7-6), wherein a solid phase substrate is made of a plastic.
(7-8) The biochip as set forth in (7-7), wherein the plastic is a saturated cyclic polyolefin.
(7-9) The biochip as set forth in any one of (7-1) to (7-6), wherein a solid phase substrate is made of a glass.
(7-10) A process for producing the biochip as set forth in any one of (7-1) to (7-9), the process including immobilizing a biologically active substance on the biochip substrate having on the substrate surface either a macromolecular substance having a phosphorylcholine group and an active ester group or a mixed polymer of the macromolecular substance and a polymer formed from a phosphorylcholine group and a butyl methacrylate group, and incorporating a polymer having a hydrophilic group into active ester groups of the substrate surface other than those on which the biologically active substance is immobilized.
(7-11) The process for producing a biochip as set forth in (7-10), wherein the biologically active substance is at least one of a nucleic acid, an aptamer, a protein, an oligopeptide, a sugar chain, and a glycoprotein.
(8-1) A microarray substrate for immobilizing a biologically active substance on the surface of a solid phase substrate and carrying out detection using a fluorescent dye, the microarray substrate including a macromolecular substance having a phosphorylcholine group and an active ester group on the surface of the solid phase substrate.
(8-2) The microarray substrate as set forth in (8-1), wherein the phosphorylcholine group is a 2-methacryloyloxyethyl phosphorylcholine group.
(8-3) The microarray substrate as set forth in (8-1) or (8-2), wherein the active ester group is a p-nitrophenyl ester group or an N-hydroxysuccinimide ester group.
(8-4) The microarray substrate as set forth in any one of (8-1) to
(8-3), wherein the macromolecular substance is a copolymer containing a butyl methacrylate group.
(8-5) The microarray substrate as set forth in any one of (8-1) to
(8-4), wherein the solid phase substrate is made of a plastic.
(8-6) The microarray substrate as set forth in (8-5), wherein the plastic is a saturated cyclic polyolefin.
(8-7) The microarray substrate as set forth in any one of Claims (8-1) to (8-4), wherein the solid phase substrate is made of a glass.
(8-8) A microarray that includes at least one biologically active substance among a nucleic acid, an aptamer, a protein, an oligopeptide, a sugar chain, and a glycoprotein immobilized on the microarray substrate as set forth in any one of (8-1) to (8-7).
(9-1) A biochip substrate for immobilizing a biologically active substance on the surface of a solid phase substrate, wherein a layer A is formed on the surface of the solid phase substrate and, further, a layer B is formed on the layer A, the layer A is formed from a compound A having at least one group selected from an acrylate group, a methacrylate group, a vinyl group, and an olefin group, and the layer B is formed from a polymer of a monomer having a phosphorylcholine group and a polymer of a monomer having an active ester group.
(9-2) The biochip substrate as set forth in (9-1), wherein some or all of at least one group selected from an acrylate group, a methacrylate group, a vinyl group, and an olefin group of the compound A forms a covalent bond together with a copolymer of the monomer having a phosphorylcholine group and the monomer having an active ester group of the layer B.
(9-3) The biochip substrate as set forth in (9-1) or (9-2), wherein the compound A is a silane coupling agent having at least one group selected from an acrylate group, a methacrylate group, a vinyl group, and an olefin group.
(9-4) The biochip substrate as set forth in any one of (9-1) to (9-3), wherein the monomer having a phosphorylcholine group further has a methacry group or an acrylic group.
(9-5) The biochip substrate as set forth in (9-4), wherein the monomer having a phosphorylcholine group is 2-methacryloyloxyethyl phosphorylcholine.
(9-6) The biochip substrate as set forth in any one of (9-1) to (9-5), wherein the monomer having an active ester group further has a methacry group or an acrylic group.
(9-7) The biochip substrate as set forth in any one of (9-1) to (9-6), wherein the active ester group is a p-nitrophenyl ester group or an N-hydroxysucciimide ester group.
(9-8) The biochip substrate as set forth in any one of (9-1) to (9-7), wherein the solid phase substrate is made of a plastic.
(9-9) The biochip substrate as set forth in (9-8), wherein the plastic is a saturated cyclic polyolefin.
(9-10) The biochip substrate as set forth in any one of (9-1) to (9-7), wherein the solid phase substrate is made of a glass.
(9-11) A process for producing the biochip substrate as set forth in any one of (9-1) to (9-10), the process including forming on the surface of a solid phase substrate surface a layer A having a compound A having at least one group selected from an acrylate group, a methacrylate group, a vinyl group, and an olefin group, and then forming a layer B by copolymerizing on the layer A a monomer having a phosphorylcholine group and a monomer having an active ester group.
(9-12) A biochip that includes a biologically active substance immobilized on the biochip substrate as set forth in any one of (9-1) to (9-10).
(10-1) A biochip that includes a substrate, a channel provided on the substrate, and on the channel a macromolecular substance containing a first unit having a phosphorylcholine group and a second unit having a carboxylic acid derivative group, the carboxylic acid derivative group and a capture substance for capturing a biologically active substance reacting to form a covalent bond.
(10-2) The biochip as set forth in (10-1), wherein the biochip includes a plurality of carboxylic acid derivative groups, and the plurality of carboxylic acid derivative groups react with the capture substance to form a covalent bond or are deactivated.
(10-3) The biochip as set forth in (10-1) or (10-2), wherein the carboxylic acid derivative group is an active ester group.
(10-4) The biochip as set forth in (10-3), wherein the active ester group has a p-nitrophenyl group or an N-hydroxysuccinimide group.
(10-5) A biochip that includes a substrate, a channel provided on the substrate, and on the surface of the channel a macromolecular substance containing a first unit having a phosphorylcholine group and a second unit having a monovalent group represented by formula (1) below, the monovalent group represented by formula (1) and a capture substance for capturing a biologically active substance reacting to form a covalent bond.

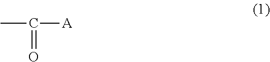

(In formula (1) above, A is a monovalent leaving group other than a hydroxyl group.)
(10-6) The biochip as set forth in (10-5), wherein the monovalent group represented by formula (1) is any group selected from formula (p) and formula (q) below.

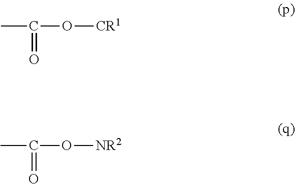

(In formula (p) and formula (q) above, R¹ and R² independently denote a monovalent organic group and may be any one of a straight chain, a branched chain, and a cyclic chain. Furthermore, in formula (p) above, R¹ may be a divalent group that, together with C, forms a ring. Furthermore, in formula (q) above, R² may be a divalent group that, together with N, forms a ring.)
(10-7) The biochip as set forth in any one of (10-1) to (10-6), wherein the first unit containing a phosphorylcholine group has a 2-methacryloyloxyethyl phosphorylcholine group.
(10-8) The biochip as set forth in any one of (10-1) to (10-7), wherein the macromolecular substance has a third unit containing a butyl methacrylate group.
(10-9) The biochip as set forth in (10-1) to (10-8), wherein the material for the substrate is a plastic.
(10-10) The biochip as set forth in any one of (10-1) to (10-9), wherein the biochip includes a protecting member covering the channel.
(10-11) The biochip as set forth in (10-10), wherein at least one of a material for the substrate and a material for the protecting member is a plastic that is transparent to detection light.
(10-12) The biochip as set forth in (10-1) to (10-11), wherein the material for the substrate is a glass.
(10-13) The biochip as set forth in any one of (10-1) to (10-12), wherein the capture substance is one or more substances selected from the group consisting of a nucleic acid, an aptamer, a protein, an enzyme, an antibody, an oligopeptide, a sugar chain, and a glycoprotein.
(10-14) The biochip as set forth in any one of (10-1) to (10-13), wherein the biologically active substance is one or more substances selected from the group consisting of a nucleic acid, an aptamer, a protein, an enzyme, an antibody, an oligopeptide, a sugar chain, and a glycoprotein.

### INDUSTRIAL APPLICABILITY

Since in the biochip of the present invention there is little nonspecific adsorption of a biologically active substance such as a protein, loss of the biologically active substance as a target in a sample is suppressed, a specific interaction such as an antigen-antibody reaction occurs efficiently, and it is therefore possible to detect the biologically active substance with high sensitivity in a short period of time. Furthermore, the constitution is such that autofluorescence of the substrate is suppressed and adsorption of a fluorescent dye is reduced, and it is therefore possible to increase the S/N ratio and precisely detect a sample signal.

1. A biochip substrate comprising a macromolecular substance on the surface of a substrate, the macromolecular substance containing a first unit having a phosphorylcholine group and a second unit having an active ester group, wherein the active ester group has a higher activity than alkyl esters.

2. The biochip substrate as set forth in claim 1, wherein
said macromolecular substance contains a third unit having a butyl methacrylate group, and
the proportion of said phosphorylcholine group contained in said macromolecular substance relative to the total of said phosphorylcholine group, said active ester group, and said butyl methacrylate group is at least 20 mol % but less than 40 mol %.

3. The biochip substrate as set forth in claim 1, wherein
said macromolecular substance contains a third unit having a butyl methacrylate group, and
the proportion of said phosphorylcholine group contained in said macromolecular substance relative to the total of said phosphorylcholine group, said active ester group, and said butyl methacrylate group is at less than 3 mol % and not more than 40 mol %.

4. The biochip substrate as set forth in claim 1, wherein
said macromolecular substance contains a third unit having a butyl methacrylate group, and
the proportion of said active ester group contained in said macromolecular substance relative to the total of said phosphorylcholine group, said active ester group, and said butyl methacrylate group is at least 15 mol % but less than 25 mol %.

5. The biochip substrate as set forth in claim 1, wherein
said macromolecular substance contains a third unit having a butyl methacrylate group, and
the proportion of said active ester group contained in said macromolecular substance relative to the total of said phosphorylcholine group, said active ester group, and said butyl methacrylate group is not less than 1 mol % and not more than 25 mol %.

6. The biochip substrate as set forth in claim 1, wherein the macromolecular substance further includes a macromolecule containing a first unit having a phosphorylcholine group and a third unit having a butyl methacrylate group.

7. The biochip substrate as set forth in claim 6, wherein the proportion of the phosphorylcholine group contained in said macromolecular substance relative to the total of said phosphorylcholine group, said active ester group, and said butyl methacrylate group is at least 20 mol % but less than 40 mol %.

8. The biochip substrate as set forth in claim 6, wherein the proportion of the phosphorylcholine group contained in said macromolecular substance relative to the total of said phosphorylcholine group, said active ester group, and said butyl methacrylate group is not less than 3 mol % and not more than 40 mol %.

9. The biochip substrate as set forth in claim 6, wherein the proportion of said active ester group contained in said macromolecular substance relative to the total of said phosphorylcholine group, said active ester group, and said butyl methacrylate group is at least 15 mol % but less than 25 mol %.

10. The biochip substrate as set forth in claim 6, wherein the proportion of said active ester group contained in said macromolecular substance relative to the total of said phosphorylcholine group, said active ester group, and said butyl methacrylate group is not less than 1 mol % and not more than 25 mol %.

11-13. (canceled)

14. The biochip substrate as set forth in claim 1, wherein
said first unit containing a phosphorylcholine group has a 2-methacryloyloxyethyl phosphorylcholine group.

15. The biochip substrate as set forth in claim 1, wherein said macromolecular substance has a third unit containing a butyl methacrylate group.

16. The biochip substrate according to claim 1, and further comprising
a first layer formed on the substrate, and
wherein the macromolecular substance is present in a second layer that is formed on the first layer, and
said first layer being formed from a compound having at least one group selected from an acrylate group, a methacrylate group, a vinyl group, and an alkenyl group.

17. The biochip substrate according to claim 1, and further comprising
a first layer provided on said substrate and formed from an organosiloxane, and
wherein the macromolecular substance is present in a second layer provided on the first layer.

18. The biochip substrate as set forth in claim 16, wherein
at least one group of said compound, the group being selected from an acrylate group, a methacrylate group, a vinyl group, and an alkenyl group, forms a covalent bond with said copolymer of said second layer.

19. The biochip substrate as set forth in claim 16, wherein
said first layer is formed from a silane coupling agent having at least one group selected from an acrylate group, a methacrylate group, a vinyl group, and an alkenyl group.

20. The biochip substrate as set forth in claim 19, wherein the monomer having a phosphorylcholine group has a methacrylic group or an acrylic group.

21. The biochip substrate as set forth in claim 19, wherein the monomer having a phosphorylcholine group is 2-methacryloyloxyethyl phosphorylcholine.

22. The biochip substrate as set forth in claim 16, wherein the monomer having an active ester group has a methacrylic group or an acrylic group.

23. The biochip substrate as set forth in claim 1, wherein said active ester group includes a p-nitrophenyl group or an N-hydroxysuccinimide group.

24. The biochip substrate as set forth in claim 1, wherein a material for said substrate is a plastic.

25. The biochip substrate as set forth in claim 24, wherein said plastic is a saturated cyclic polyolefin.

26. The biochip substrate as set forth in claim 1, wherein a material for said substrate is a glass.

27-39. (canceled)

40. The biochip substrate according to claim 1, and further comprising a capture substance for capturing a biologically active substance immobilized thereon.

41. The biochip substrate according to claim 1, wherein said active ester group is covalently bonded to the capture substance.

42. The biochip substrate according to claim 1, and further comprising a plurality active ester groups having higher activity than alkyl esters,
wherein some of said active ester groups are covalently bonded to the capture substance, and
the remainder of said active ester groups are covalently bonded to a hydrophilic polymer having a hydrophilic group.

43. The biochip substrate as set forth in claim 42, wherein said hydrophilic polymer has an amino group.

44. The biochip substrate as set forth in claim 42, wherein said hydrophilic polymer includes in its structure a polyalkylene oxide or a plurality of types of said polyalkylene oxide.

45. The biochip substrate as set forth in claim 41, wherein a material for said substrate is a plastic.

46. The biochip substrate as set forth in claim 45, wherein said plastic is a saturated cyclic polyolefin.

47. A biochip comprising
the biochip substrate according to claim 1, and
a channel provided on said substrate and, on the surface of said channel,
wherein said active ester group is covalently bonded to the capture substance.

48. The biochip as set forth in claim 47,
wherein the biochip substrate comprises a plurality of said active ester groups, and
said plurality of active ester groups are covalently bonded to the capture substance and ester groups which are not covalently bonded to the capture substance are deactivated ester groups.

49. The biochip as set forth in claim 47, wherein the biochip comprises a protecting member covering said channel.

50. The biochip as set forth in claim 49, wherein at least one of a material for said substrate and a material for said protecting member is a plastic.

51. The biochip as set forth in claim 47, wherein a material for said substrate is a plastic that is transparent to detection light.

52. The biochip as set forth in claim 41, wherein said biologically active substance is captured by said capture substance.

53. The biochip as set forth in claim 41, wherein said first unit containing a phosphorylcholine group has a 2-methacryloyloxyethyl phosphorylcholine group.

54. The biochip as set forth in claim 41, wherein said active ester group has a p-nitrophenyl group or an N-hydroxysuccinimide group.

55. The biochip as set forth in claim 41, wherein said macromolecular substance has a third unit containing a butyl methacrylate group.

56. The biochip as set forth in claim 41, wherein a material for said substrate is a glass.

57. The biochip as set forth in claim 41, wherein said capture substance is one or more materials selected from the group consisting of a nucleic acid, an aptamer, a protein, an enzyme, an antibody, an oligopeptide, a sugar chain, and a glycoprotein.

58. The biochip as set forth in claim 41, wherein the biochip is formed by immobilizing a capture substance for capturing a biologically active substance on the surface of said substrate under neutral or alkaline conditions.

59. The biochip as set forth in claim 41, wherein said biologically active substance is one or more materials selected from the group consisting of a nucleic acid, an aptamer, a protein, an enzyme, an antibody, an oligopeptide, a sugar chain, and a glycoprotein.

60-68. (canceled)

69. A microarray comprising, immobilized on the microarray substrate as set forth in claim 1,
one or more said capture substances selected from the group consisting of a nucleic acid, an aptamer, a protein, an enzyme, an antibody, an oligopeptide, a sugar chain, and a glycoprotein.

70. (canceled)

71. A process for producing the biochip substrate as set forth in claim 16, the process comprising
forming said first layer on said substrate, and then
forming said second layer by copolymerizing on said first layer said monomer having a phosphorylcholine group and said monomer having an active ester group, wherein the active ester group has a higher activity than alkyl esters.

72. A method for using the biochip substrate as set forth in claim 1, the method comprising
(1) immobilizing a capture substance for capturing a biologically active substance on said substrate under neutral or alkaline conditions, and
(2) contacting the surface of said microchip substrate with a liquid containing a biologically active substance to be detected and having a pH that is equal to or less than said conditions to thus make said capture substance capture said biologically active substance.

73. The method for using a biochip substrate as set forth in claim 72,
wherein said capture substance is one or more materials selected from the group consisting of a nucleic acid, an aptamer, a protein, an enzyme, an antibody, an oligopeptide, a sugar chain, and a glycoprotein.

74. The method for using a biochip substrate as set forth in claim 72,
wherein said biologically active substance to be detected is one or more materials selected from the group consisting of a nucleic acid, an aptamer, a protein, an enzyme, an antibody, an oligopeptide, a sugar chain, and a glycoprotein.

75. A process for producing a biochip using the biochip substrate as set forth in claim 1, said biochip substrate having a plurality of said active ester groups, the process comprising
immobilizing said capture substance by reacting some of said active ester groups with said capture substance, and
deactivating the remainder of said active ester groups after said immobilizing the capture substance.

76. The process for producing a biochip as set forth in claim 75, wherein said deactivating the remainder of the active ester groups is carried out using an alkaline compound.

77. The process for producing a biochip as set forth in claim 75, wherein said deactivating the remainder of the active ester groups is carried out using a compound having a primary amino group.

78. The process for producing a biochip as set forth in claim 77, wherein said compound having a primary amino group is aminoethanol or glycine.

79. The process for producing a biochip as set forth in claim 75, wherein said capture substance is one or more materials selected from the group consisting of a nucleic acid, an aptamer, a protein, an enzyme, an antibody, an oligopeptide, a sugar chain, and a glycoprotein.

80. A process for producing the biochip as set forth in claim 41, the process comprising
contacting said surface of said substrate with an acidic or neutral liquid containing said capture substance.

81. A process for producing the biochip as set forth in claim 42, the process comprising
immobilizing said capture substance by reacting some of said active ester groups of said biochip substrate with said capture substance to form a covalent bond, and
reacting the remainder of said active ester groups and said hydrophilic polymer to form a covalent bond after said immobilizing the capture substance.
